(19) United States
(12) Patent Application Publication
(10) Pub. No.: US 2025/0342397 A1
(43) Pub. Date: Nov. 6, 2025

(54) GEOSPATIAL MOVING ENTITY ANALYSIS WITH MISSING VALUE IMPUTATION

(71) Applicant: Lovelace Al Inc., Pittsburgh, PA (US)

(72) Inventors: Andrew W. Moore, Pittsburgh, PA (US); Leah Nicolich-Henkin, Pittsburgh, PA (US); Jonathan Macoskey, Pittsburgh, PA (US); Arkady Epshteyn, Pittsburgh, PA (US)

(21) Appl. No.: 18/930,518

(22) Filed: Oct. 29, 2024

Related U.S. Application Data
(60) Provisional application No. 63/642,631, filed on May 3, 2024.

(51) Int. Cl. G06N 20/00; G06F 16/23

(52) U.S. Cl. CPC G06N 20/00; G06F 16/2365

(57) ABSTRACT

Various example embodiments provide for systems, methods, techniques, instruction sequences, and devices for geospatial analysis of one or more moving entities (or moving objects). In particular, various embodiments provide for imputing a missing value of an attribute of a moving entity. One or more missing values imputed by various example embodiments can be used to provide complete information regarding a moving entity, and can also be used by a geospatial moving entity analysis system to detect when a moving entity is reporting strange or anomalous attribute values.

### CROSS-REFERENCE TO RELATED APPLICATIONS

This application claims priority to and the benefit of U.S. Provisional Patent Application No. 63/642,631, entitled “GEOSPATIAL MOVING ENTITY ANALYSIS SYSTEMS AND METHODOLOGIES,” filed on May 3, 2024, which is incorporated herein by reference in its entirety.

### TECHNICAL FIELD

The present disclosure relates generally to moving entities, and, more particularly, various example embodiments described herein provide for systems, methods, techniques, instruction sequences, and devices for geospatial analysis of one or more moving entities (or moving objects).

### BACKGROUND

The field of geospatial analytics has seen significant advancements in recent years, driven by the increasing availability of location data and the development of sophisticated computational techniques. Geospatial analytics involves the gathering, display, and manipulation of imagery, geosynchronous positional system (GPS), satellite photography, and historical data, which are tied to location-specific coordinates. This field has applications across various industries, including transportation, logistics, urban planning, environmental monitoring, and more.

### BRIEF DESCRIPTION OF DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some example embodiments are illustrated by way of example, and not limitation, in the figures of the accompanying drawings.

FIG. 1 is a diagrammatic representation of a networked environment in which an example geospatial moving entity analysis system of various example embodiments may be deployed.

FIG. 2 is a block diagram illustrating an example implementation of a geospatial moving entity analysis system, according to various example embodiments of the present disclosure.

FIG. 3 is a diagram illustrating the two-stage entity resolution approach, in accordance with some example embodiments of the present disclosure.

FIG. 4 and FIG. 5 illustrate examples graphical user interfaces that enable a user of a geospatial moving entity analysis system to access one or more of the geospatial moving entity analysis system's features, in accordance with some example embodiments of the present disclosure.

FIG. 6 is a diagram illustrating an example joining/merging algorithm used for trajectory prediction, in accordance with some example embodiments of the present disclosure.

FIG. 7 shows details of an example momentum calculation used for trajectory prediction, in accordance with some example embodiments of the present disclosure.

FIG. 8 illustrates an example of a spatial distribution of probabilities at future time intervals determined during trajectory prediction, in accordance with some example embodiments of the present disclosure.

FIG. 9 shows example equations for parameters of a bivariate normal distribution used in generating a cluster, in accordance with some example embodiments of the present disclosure.

FIG. 10 shows an example probability density function and example distributions, in accordance with some example embodiments of the present disclosure.

FIG. 11 shows an example objective function for a k-nearest-neighbor algorithm, in accordance with some example embodiments of the present disclosure.

FIG. 12 is a diagram example of examining the historical paths of ships, in accordance with some example embodiments of the present disclosure.

FIG. 13 illustrates an example definition of mean squared error used during trajectory prediction, in accordance with some example embodiments of the present disclosure.

FIG. 14 illustrates an example definition for a decision variable used during trajectory prediction, in accordance with some example embodiments of the present disclosure.

FIG. 15 illustrates an example of how contextual information regarding a moving entity and historical locations of the moving entity enable a geospatial foundation model to generate a spatial sequence (location) prediction for the moving entity, in accordance with some example embodiments of the present disclosure.

FIG. 16 illustrates example ways a location on the globe can be represented, in accordance with some example embodiments of the present disclosure.

FIG. 17 shows examples of spherical geometry, basic math, and cross products used, in accordance with some example embodiments of the present disclosure.

FIG. 18 and FIG. 19 illustrate example math for the intersection of two lines and intersection points on two Great Circles, in accordance with some example embodiments of the present disclosure.

FIG. 20, FIG. 21, FIG. 22, FIG. 23, FIG. 24, and FIG. 25 illustrate examples graphical user interfaces that enable a user of a geospatial moving entity analysis system to access one or more of the geospatial moving entity analysis system's features, in accordance with some example embodiments of the present disclosure.

FIG. 26 is a flowchart illustrating an example method for imputing a missing value of an attribute of a moving entity, according to various example embodiments of the present disclosure.

FIG. 27 is a block diagram showing a software architecture within which the present disclosure may be implemented, according to some examples.

FIG. 28 is a diagrammatic representation of a machine in the form of a computer system within which a set of instructions may be executed for causing the machine to perform any one or more of the methodologies discussed herein, in accordance with some examples.

### DETAILED DESCRIPTION

Advances in various areas of geospatial analysis with respect to one or more moving entities (or objects), such as people and different types of vehicles (e.g., ships, automotive vehicles, aircraft, etc.), could significantly enhance the capabilities of geospatial analysis systems and methodologies and can provide useful insights into understanding or predicting movements of one or more moving entities. For instance, traditional methods of trajectory prediction of a moving entity often rely on simple extrapolation techniques that may not account for complex patterns of movement or interactions with other static or moving entities. Traditional geospatial analysis systems can have difficulty addressing missing data or values (e.g., missing geospatial data) with respect to moving entities, which can result from known issues such as a sensor malfunction, a transmission error, or incomplete reporting. Additionally, traditional geospatial analysis systems can have difficulty managing the connectedness of moving entity information, such as the relationships between entities or the association of entities with organizations.

One or more various example embodiments described herein address these and other deficiencies present in conventional geospatial analysis technologies. In particular, some example embodiments provide a geospatial moving entity analysis system capable of inferring information about moving entities by analyzing known data about the entities, their associations, their historical geospatial movements, predicted geospatial movements, or some combination thereof. A system of various example embodiments comprises a trajectory prediction feature configured to interpolate and predict one or more paths of a moving entity between known points, thereby enhancing the understanding of where the moving entity has been and where it is likely to go. A system of various example embodiments comprises missing data or value imputation, which can predict likely values for one or more missing attribute values of a moving entity (e.g., based on other reported or known attribute values) and can provide a rationale (or explanation) for the predictions (e.g., based on other reported/known attribute values). A system of various example embodiments comprises an Entity resolution feature, which can resolve identities of moving entities by determining, for example, whether different known or observed data points (e.g., cell phone signals or ship reports) actually belong to the same moving entity. The Entity resolution feature can also assess the connectedness of a moving entity (e.g., by identifying relationships between a moving entity and one or more static entity or moving entities, such as friendships, organizational memberships, or corporate ownership). A system of some example embodiments implements multi-modal data fusion, which can enable or facilitate integration of data of different data types to enhance the prediction and inference capabilities of the system. A system of some example embodiments is capable of statefulness, where one or more historical facts about a given moving entity are used to predict the moving entity's current state. Additionally, a system of some example embodiments comprises a hypothetical, parallel, alternative universe mode, where under the mode a user can simulate decisions or conditions for one or more moving entities and observe the outcomes of these simulated decisions/conditions on the movement or behavior of the one or more moving entities (or of one or more other entities) within the hypothetical/parallel/alternate reality. Overall, a system implementing an example embodiment can provide a user with a robust and comprehensive understanding of moving entities within a geospatial context.

To enable one or more features described herein, the geospatial moving entity analysis system of some example embodiments applies one or more artificial intelligence (AI) model technologies, such as transformers (e.g., a transformer similar to that of a large language model) and other generative models, to the domain of spatiotemporal or geospatial movement predictions. As used herein, a foundational model used by a system can refer to an AI model that is trained on a large amount of data (e.g., somewhat agnostic of task) and that can then be fine-tuned to apply to a variety of different downstream tasks. some example embodiments apply generative model techniques to the realm of geospatial data, thereby offering a unique method for understanding and predicting movement of moving entities through space and time. For example, a spatiotemporal or geospatial location (e.g., coordinates, such as map coordinates provided by a geosynchronous positional system (GPS)) of a moving entity can be treated as a “token” (similar to how a word can be treated as a token in natural language processing) with respect to one or more AI models (e.g., foundational models). These can be referred to as location tokens herein. One or more location tokens of a moving entity can be provided as input to one or more generative models, and the one or more generative models can generate (as output) a sequence of one or more location tokens for the moving entity based on the input. In this manner, various example embodiments can use one or more AI models to analyze a sequence of location tokens, which can be considered spatiotemporal or geospatial “sentences,” of a moving entity and to predict a subsequent spatiotemporal/geospatial sentence for the moving entity, thereby forecasting or predicting where a moving entity may be heading. Each location token of a moving entity can comprise a spatiotemporal or geospatial location of the moving entity within a defined space, and can further comprise a data or a time associated with the respective spatiotemporal/geospatial location (e.g., timestamp information). For some example embodiments, a system also provides the one or more AI models with contextual data, such as the entity type or object type (e.g., person, ship, automotive vehicle, aircraft), and entity metadata (e.g., depending on the entity/object type, nationality/country of origin, age, job, manufacture date, previous cargo, etc.). By providing the contextual data, a system can enable the one or more AI models to develop a semantic description or understanding of spatiotemporal or geospatial movements of a moving entity, and of one or more latent variables that lead to the observations of those movements. With respect to preparing one or more AI models for use by a system, for some example embodiments, an AI model is provided with a latent understanding of time and the three-dimensional space (e.g., of the planet) around us, such as roads, coastlines, weather patterns, and the like, thereby enabling the AI model to reason about its predictions (which is a capability that is typically challenging for conventional language model systems (LLMs)).

To support one or more features described herein, the geospatial moving entity analysis system of some example embodiments uses a unique spherical geometry system, where lines on the surface of spheres (e.g., representing the surface of a planet) are always defined as the shortest great circle arc. Additionally, for some example embodiments, the new spherical geometry system allows the possibility of directional lines to cover where there is a longer great circle arc.

As used herein, an AI model can refer to a generative AI model, such as transformers, and other types of AI models, such as embedding models and other machine learning (ML) models.

As used herein, a mobile device can comprise a mobile computing device (e.g., laptop, or tablet), a cell phone (e.g., smart phone), or a transponder, such as an animal tracker.

Reference will now be made in detail to various example embodiments of the present disclosure, examples of which are illustrated in the appended drawings. The present disclosure may, however, be embodied in many different forms and should not be construed as being limited to the examples set forth herein.

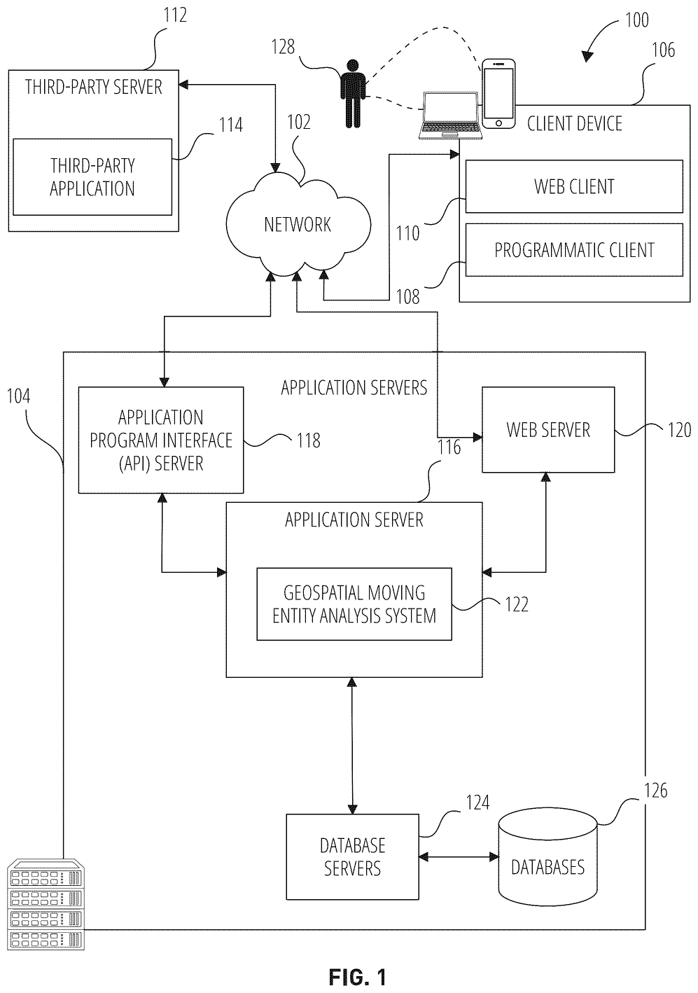

FIG. 1 is a diagrammatic representation of a networked computing environment 100 in which some examples of the present disclosure may be implemented or deployed.

One or more application servers 104 provide server-side functionality via a network 102 to a networked user device, in the form of a client device 106 that is accessed by a user 128. A web client 110 (e.g., a browser) and a programmatic client 108 (e.g., an “app”) are hosted and executed on the web client 110. While certain functions are described herein as being performed by the geospatial moving entity analysis system 122 on the application servers 104, it will be appreciated that the location of certain functionality within the application servers 104 is a design choice. For example, it may be technically preferable to initially deploy certain technology and functionality within the application servers 104, but to later migrate this technology and functionality to the programmatic client 108 where the client device 106 performs methodologies described herein.

An Application Program Interface (API) server 118 and a web server 120 provide respective programmatic and web interfaces to application servers 104. A specific application server 116 hosts a geospatial moving entity analysis system 122, which includes components, modules and/or applications.

The web client 110 communicates with the geospatial moving entity analysis system 122 via the web interface supported by the web server 120. Similarly, the programmatic client 108 communicates with the geospatial moving entity analysis system 122 via the programmatic interface provided by the Application Program Interface (API) server 118.

The application server 116 is communicatively coupled to database servers 124, facilitating access to an information storage repository or databases 126. In some examples, the databases 126 includes storage devices that store information to be published and/or processed by the geospatial moving entity analysis system 122.

Additionally, a third-party application 114 executing on a third-party server 112, has programmatic access to the application server 116 via the programmatic interface provided by the Application Program Interface (API) server 118. For example, the third-party application 114, using information retrieved from the application server 116, may support one or more features or functions on a website hosted by a third party.

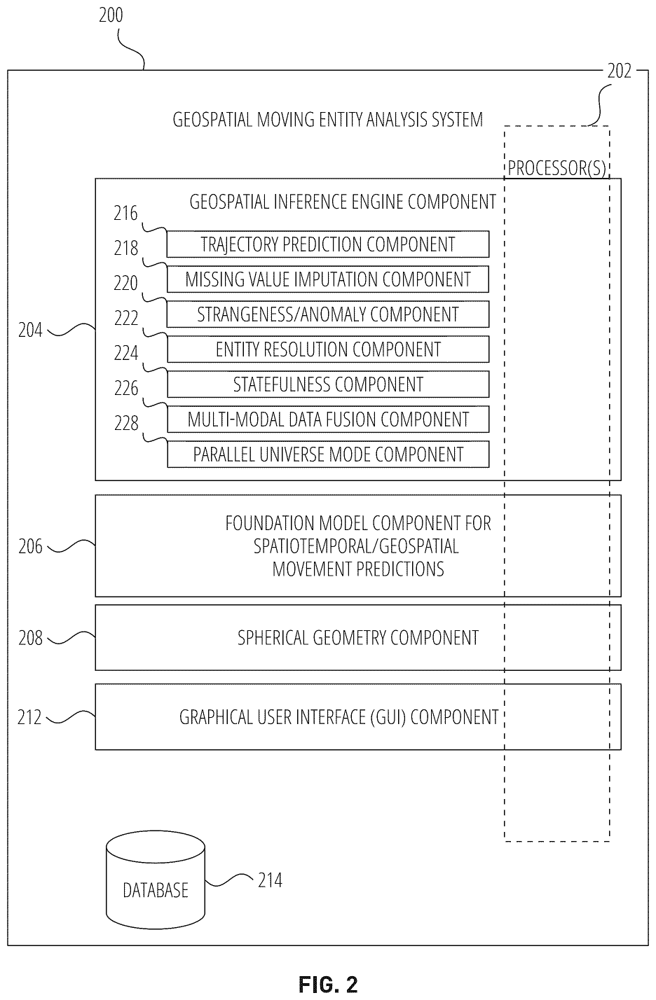

FIG. 2 is a block diagram illustrating an example implementation of a geospatial moving entity analysis system 200, according to various example embodiments of the present disclosure. For some example embodiments, the geospatial moving entity analysis system 200 represents an example of the geospatial moving entity analysis system 122 described with respect to FIG. 1. As shown, the geospatial moving entity analysis system 200 comprises a geospatial inference engine component 204, a foundation model component for spatiotemporal/geospatial movement predictions 206 (hereafter foundation model component 206), a spherical geometry component 208, and a graphical user interface component 212. According to various example embodiments, one or more of the geospatial inference engine component 204, the foundation model component 206, the spherical geometry component 208, and the graphical user interface component 212 are implemented by one or more processors 202. Data generated by, or used by, one or more of the geospatial inference engine component 204, the foundation model component 206, the spherical geometry component 208, and the graphical user interface component 212 is stored on a database (or datastore) 214 of the geospatial moving entity analysis system 200.

The geospatial inference engine component 204 is configured to provide geospatial entity intelligence by inferring information about a moving entity. Specifically, for some example embodiments, the geospatial inference engine component 204 enables the geospatial moving entity analysis system 200 to infer information about moving (or mobile) entities based on what the geospatial moving entity analysis system 200 knows about them, knows about their “friends” or “neighbors” (e.g., depending on the type of moving entity (e.g., could be literal friends or could be vehicles of the same group), such as ships of the same fleet), and knows about their geospatial location history and predicted future geospatial location(s). Accordingly, the geospatial inference engine component 204 (or various sub-components thereof) can be configured to implement one or more different inference features of the geospatial moving entity analysis system 200 described herein.

For example, a trajectory prediction component 216 of the geospatial inference engine component 204 can enable the geospatial moving entity analysis system 200 to perform trajectory interpolation (e.g., interpolate where a moving entity has been between known points A and B) and to perform geospatial prediction (e.g., predict where the moving entity is going from point B onwards). For example, the geospatial moving entity analysis system 200 can predict the future geospatial location of a moving entity based on its past geospatial locations. A missing value imputation component 218 of the geospatial inference engine component 204 can enable the geospatial moving entity analysis system 200 to perform missing value imputation with explanation of imputation(s). The ability to accurately predict missing values can be crucial for maintaining the integrity of geospatial data and ensuring that subsequent analyses are based on complete and reliable information. An entity resolution component 222 of the geospatial inference engine component 204 can enable the geospatial moving entity analysis system 200 to perform entity resolution. Entity resolution can comprise identifying and linking multiple records that refer to the same real-world entity, which can involve resolving data discrepancies, such as different spellings of names, reporting errors, or the use of various identifiers for the same entity. For instance, entity resolution can determine that three cell phones belong to the same person, that two ships with different name spellings are actually the same ship, or that two ships reporting the same Maritime Mobile Service Identity (MMSI) are actually not the same ship. The geospatial inference engine component 204 can enable the geospatial moving entity analysis system 200 to entity connectedness with one or more other entities (e.g., static or moving entities). For instance, the geospatial moving entity analysis system 200 can determine that people are friends with each other, that ships belong to the same organization or fleet, that companies are owned by the same corporate entity, and the like. A statefulness component 224 of the geospatial inference engine component 204 can enable the geospatial moving entity analysis system 200 to maintain statefulness of a moving entity. For example, the geospatial moving entity analysis system 200 can use an AI model to predict a current state of a moving entity based on known prior facts regarding the moving entity. A multi-modal data fusion component 226 of the geospatial inference engine component 204 can implement inference features of the geospatial moving entity analysis system 200 using multi-modal data fusion. The integration of multi-modal data, which can include combining data from various sources and formats, can enhance the accuracy and richness of geospatial analysis. A parallel universe mode component 228 of the geospatial inference engine component 204 can enable the geospatial moving entity analysis system 200 to operate in a hypothetical, parallel, or alternate universe mode, which can allow a user to decisions for particular moving entities (e.g., “switch the port of destination for these 10 ships from Baltimore to Boston”) and then lets this alternate universe play out and affect the movement and decisions of other moving entities. Such simulations can be valuable for planning and decision-making purposes, and involve complex models that can account for the interdependencies between moving entities and their environment.

To facilitate the one or more inference features described herein, the geospatial inference engine component 204 can use one or more AI models or methodologies, including, for example, a Bayesian network. The following describes certain inference features in greater detail.

The trajectory prediction component 216 of the geospatial inference engine component 204 is configured to forecast or project a trajectory of a moving entity by way of an algorithm that provides a spatial distribution of probabilities for any given future time step prediction, and updates the objective function to weight moving entities (e.g., ships) with similar attributes more highly when making a prediction. According to some example embodiments, the trajectory prediction component 216 performs the algorithm as follows. First, a moving entity (e.g., ship) can be selected for trajectory prediction. Next, a time interval for each future time step prediction is selected, and a duration of the trajectory prediction is selected. To generate a distribution of the probability distribution of the paths that the current, selected ship can take, the trajectory prediction component 216 samples from the path of the neighbors and the selected ship's historical paths. The trajectory prediction component 216 can start with a current_Time−n_hours back in time for the path that the selected ship is on. For each time interval since this start time (start_Time), the trajectory prediction component 216 can perform the following operations.

The trajectory prediction component 216 uses the k-nearest-neighbor search algorithm to obtain a set of k moving entities. For example, the set of k moving entities (e.g., 30 ships) could be those that most closely resemble the selected ship's location, speed, heading, or a combination thereof. The trajectory prediction component 216 then follows these ship paths for a period of (duration−current_Time). The trajectory prediction component 216 collects a list of n points, with each point being the location of the ship if the ship were to travel along this ship path after x number of time intervals. For example, if we have a time interval of 1 hour, and we want a duration of 5 hours, then we will create a list of 5 points with each point being the location of the ship if the boat were to take this ship path. The duration of this ship path can change as the trajectory prediction component 216 finds ship paths further into the future.

For all the ship locations at a particular time step (e.g., a time step defined as one time interval since the start_Time), the trajectory prediction component 216 uses a lasso algorithm (which can treat all points covered in the same circle as a singular point, such as moving entities that are within “radius” apart) to generate two or more moving entity clusters based on the set of k moving entities (e.g., based on their resemblance to each other). Each cluster can comprise one or more ships from the set of k ships, and each ship belong to exactly one cluster.

For each cluster generated by the lasso algorithm (e.g., each cluster would form a branching path in subsequent time steps), the trajectory prediction component 216 applies a bivariate (e.g., Gaussian) distribution to moving entities within the cluster, shift the heading vectors of the moving entities in the cluster onto the current location of the moving entities of interest, average the vectors, and apply the selected time step to the predicted velocity and heading to pick a new location. Thereafter, the trajectory prediction component 216 combines the bivariate distributions from each branch to create a global distribution. The trajectory prediction component 216 can repeat the algorithm for each branch starting with sampling from the path of the neighbors and the selected ship's historical paths.

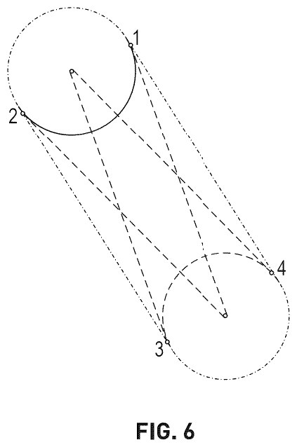

As described herein, the trajectory prediction component 216 can use a lasso algorithm to generate one or more moving entity clusters based on a set of moving entities. According to some example embodiments, the lasso algorithm generates a polygonal region surrounding a trajectory by: generate a Delaunay Triangulation based on a given set of points; break the Delaunay Triangulation into two or more clusters to ensure that the distance between the nodes are no more than MaxDistance apart; for each point in a cluster, suppose it's a circle with a fixed radius and use an n-side polygon approximation to generate n points; and apply an algorithm to draw a non-convex hull around these points (n*numberOfPointsInCluster) (e.g., using an algorithm similar to one described in “Efficient generation of simple polygons for characterizing the shape of a set of points in the plane” by M. Duckham et. al.); and for each individual polygon generated, join the individual polygon with the polygon from a previous time step, unless the time step is 0, using the joining/merging algorithm. According to various example embodiments, the joining/merging algorithm comprises: starting with two polygons, computing the center of each polygon (e.g., the mean of the points in a cluster from the lasso algorithm described above); finding the first point when rotating a sweeping arm counterclockwise starting from the current cluster center across all of the points of the previous cluster; repeating this for clockwise; repeating this from the other direction (rotate a sweeping arm from the center of the previous cluster center across all of the points of the current cluster); and based on the two halves that result (as illustrated in FIG. 6, points from 1 to 2 and points 3 to 4), ordering all the points in the two halves in counterclockwise order to generate a new polygon shape. After the joining/merging algorithm, a rendering algorithm can be performed to render the polygonal regions. According to some example embodiments, the rendering algorithm comprises: given a list of joined polygons generated using the lasso algorithm, merging Algorithm, and the trajectory algorithm, rendering a shape on the UI using a n×m rectangular grid, where the rectangular grid is a Boolean grid with 1 indicating the center of the small grid is inside of a polygon from the list of the polygons and not on land.

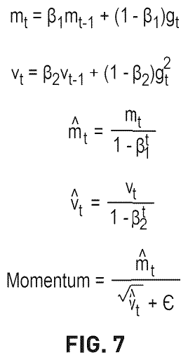

To capture the historical movements of a moving entity (e.g., ship), the trajectory prediction component 216 can use a momentum calculation. In particular, the trajectory prediction component 216 can use Adaptive Moment Estimation for neural network optimization to capture the momentum of a moving entity. The gradient can use the heading direction and magnitude of the ship. The details of the momentum calculation are illustrated in FIG. 7, where $m_t$ is the first moment estimate at time step $t$, $v_t$ is the second moment estimate at time step $t$, $\beta_1$ and $\beta_2$ are decaying parameters, and $g_t$ is the gradient at time step $t$. $\epsilon$ is a small number to avoid division by zero.

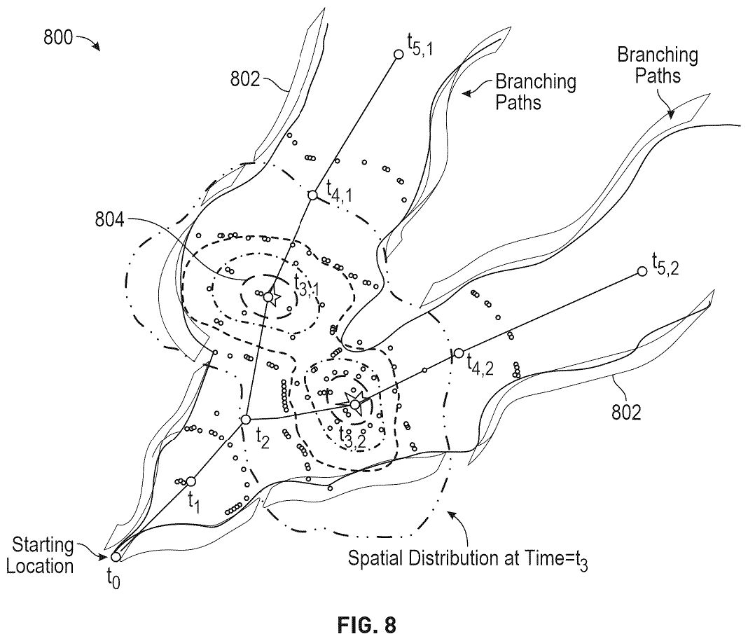

FIG. 8 illustrates an example of a spatial distribution of probabilities at future time intervals 800. In FIG. 8, the darker border 802 illustrates the “complete polygon” of all lassos for each time step. The complete polygon encapsulates all lassoed moving entities from all time steps. This can provide a user with a four-dimensional (4D) view or perspective of predicted trajectories for a moving entity (e.g., ship). The lines connecting each time step represent a “mean path” connecting each predicted location. According to some example embodiments, when a user selects (e.g., “clicks on” an element of a graphical user interface that displays the spatial distribution of probabilities at future time intervals 800 on to select) a time step, then a two-dimension (2D) normal distribution can shade the map (at 804) to indicate the highest probability region. A user can scroll through each time step to observe the changing distributions throughout the trajectory prediction.

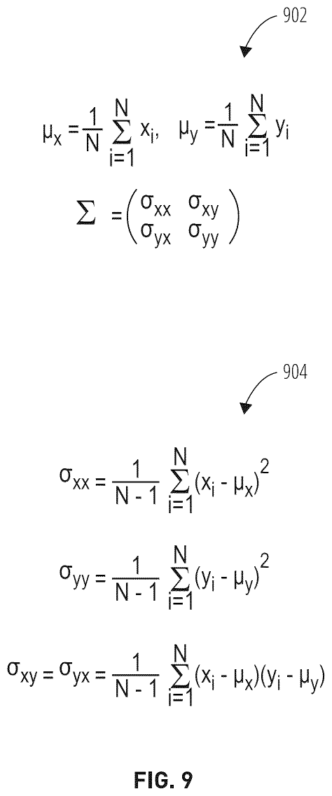

For some example embodiments, where a bivariate normal (e.g., Gaussian) distribution is used for each lasso algorithm-generated cluster of moving entities (e.g., ships), the bivariate normal distribution is parameterized by a mean vector [μx, μy] and a covariance matrix, Σ. The equations 902 for these parameters are illustrated in FIG. 9, where σxx is the variance of the x-coordinates, σyy is the variance of the y-coordinates, and σxy=σyx is the covariance between the x- and y-coordinates (see 904).

Once the separate bivariate distributions for each branch/cluster in the predicted path are determined, the trajectory prediction component 216 can combine the distributions to create one global distribution that represents the separate paths. To combine distributions (e.g., two distributions), the trajectory prediction component 216 can apply a weighted sum so that the total CDF still adds up to 1.0 across the entire spatial field.

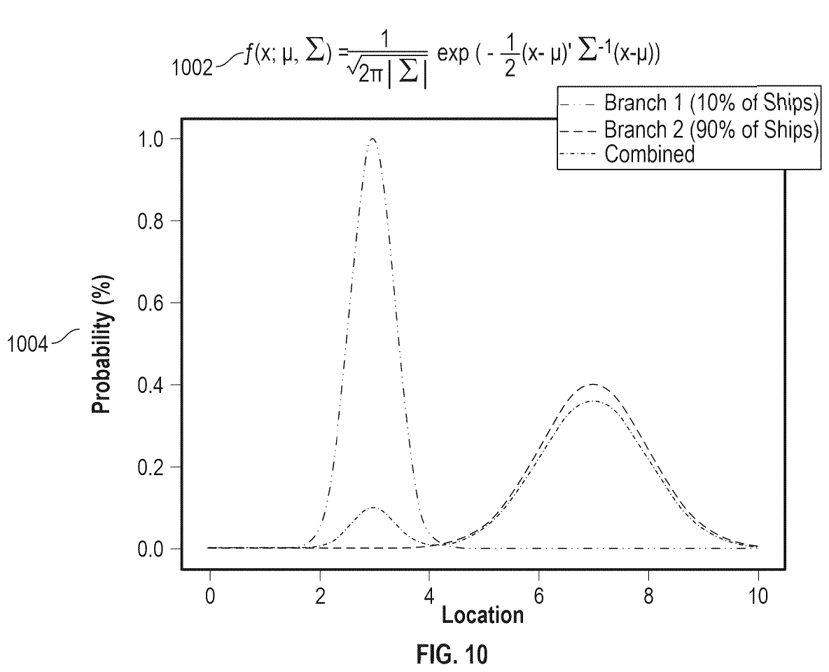

The probability density function (PDF) of the bivariate normal distribution is given by 1002 in FIG. 10. For illustrative purposes, consider two distributions in just one spatial dimension. The first distribution represents a lassoed group with 10 ships. It has a mean location of 3.0 with a standard deviation of 0.4. The second group represents a group with 90 ships. It has a mean location of 7.0 and a standard deviation of 1.0. These example distributions are illustrated in graph 1004 of FIG. 10. The combined distribution is equal to branch_1*0.1+branch_2*0.9. This combination assumes that we value all the ships in both distributions equally. If and when we update the objective function (e.g., KNN objective function) to weight ships with some similarity metric (e.g., more likely to act similarly to the ship of interest), the trajectory prediction component 216 can apply this weighting to this combination as well such that each distribution will be weighted by both the number of ships and how closely the trajectory prediction component 216 feels they represent the ship being predicted.

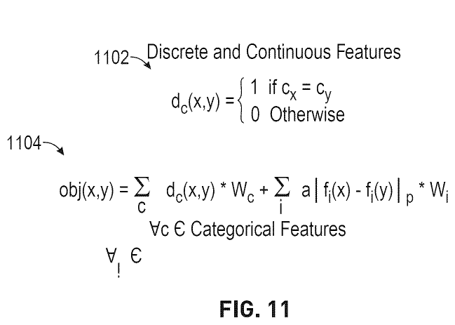

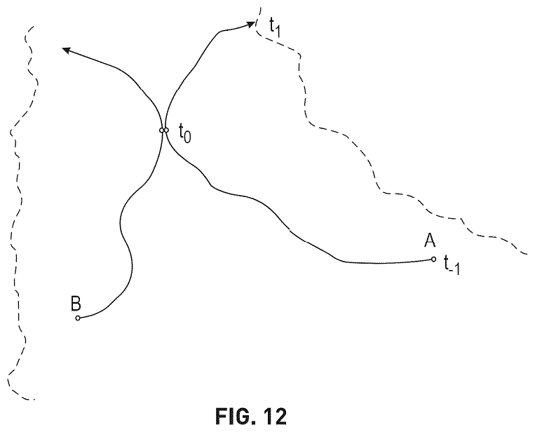

With respect to the objective function of the k-nearest-neighbor algorithm used by the trajectory prediction component 216, the trajectory prediction component 216 can use decision variables of 0 or 1 and the weight to indicate a match for all categorical values. If the trajectory prediction component 216 were category c, the decision variable can be defined as shown by equation 1102 in FIG. 11. For all discrete and continuous values, the trajectory prediction component 216 can use an appropriate norm (e.g., L1 norm or L2 norm) to compute their differences, as illustrated by equation 1104 in FIG. 11. The trajectory prediction component 216 can consider length, width, ship type, and cargo type for path prediction in addition to the original distance, heading angle, and speed. For any missing values, the decision variable can return 0. All continuous variables except distance (e.g., angle, speed, length, width) can use L1 norm and distance can use the Haversine distance. In addition to categorical features, the trajectory prediction component 216 can include prior trajectories of all entities as a part of the weighting function (e.g., captured via a momentum calculation described herein). For example, consider two ships, A, and B, illustrated in FIG. 12. At time t0, the ships appear to be near to each other. If the trajectory prediction component 216 were to use ship B to predict the location of ship A at t1, the trajectory prediction component 216 might predict that it veers off to the left instead of the right. However, if the trajectory prediction component 216 looks at the historical paths of ships A and B and weighs their trajectories with some distance metric, then the trajectory prediction component 216 would likely not include ship B in the grouping to predict the future of A.

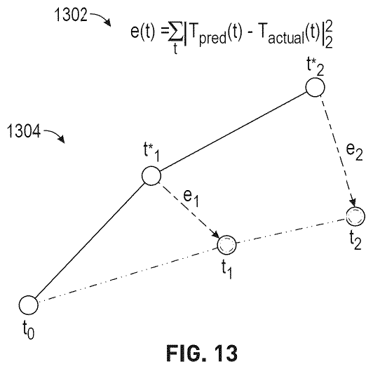

With respect to mean squared error (MSE) through time, the trajectory prediction component 216 can use the equation 1302 in FIG. 13 to define MSE with respect to a predicted trajectory T pred and an actual trajectory T actual. This is visually illustrated by diagram 1304 in FIG. 13. The trajectory prediction component 216 can redefine the L2 norm to be the Haversine distance between the trajectory locations at time step t.

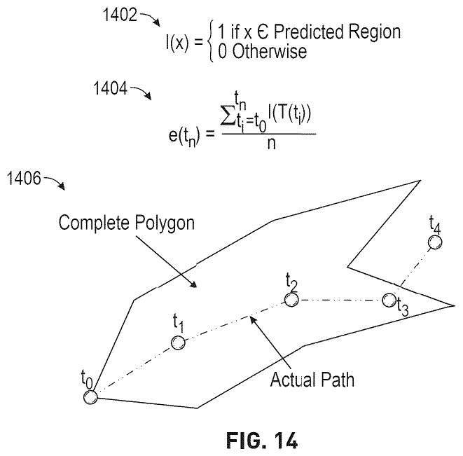

With respect to a metric to measure how often the predicted region captures the actual trajectory (capture ratio through time), the trajectory prediction component 216 can define the decision variable I according to the equation 1402 of FIG. 14 to determine if a point is located inside of the predicted region. Supposing there are n steps from the starting time to up to the current time tn, the capture ratio can be computed by the trajectory prediction component 216 as shown by equation 1404 in FIG. 14. The complete polygon 1406 in FIG. 14 illustrates the capture of three future time steps and missed one. Therefore, over a four time-step period, the particular prediction illustrated by the complete polygon 1406 resulted in a capture ratio of 75%.

The missing value imputation component 218 is configured to perform missing value imputation for entities with an explanation of imputations. Each entity (e.g., moving entity) is associated with a set of attributes, which can be reported by the entity itself (e.g., ship reports attributes about itself). The reported entity attributes are sometimes incomplete. According to some example embodiments, an imputation model of the missing value imputation component 218 can predict a likely value for an attribute that is missing an attribute value, and can include a distribution of values that would be considered within a likely range. For some example embodiments, the imputation model comprises an ML model trained on the other attributes reported by the entity having the missing attribute value. The imputation model can explain a given imputation by sharing the values of other attributes that lead to the predicted value for the attribute that is missing a value.

For example, a ship reporting its location via AIS likely also reports its flag, length, width, draught, ship type, and other similar attributes. The ship's length might be missing completely, or reported as 0. Based on the attributes that were reported properly, the imputation model of the missing value imputation component 218 can predict that the ship is actually 100 m, and that the expected distribution of lengths for the ship is a normal distribution with a mean of 100 and a standard deviation of 10. A predicted value for an attribute can represent a “most likely value” for the attribute that is missing a value, and a distribution can provide a confidence interval range (e.g., a 90% confidence interval). For instance, where an example embodiment predicts a Gaussian distribution, the example embodiment can predict a mean and a standard deviation. The mean can become the predicted value (e.g., “most likely value”) and the standard deviation can be used to calculate the confidence intervals. As another example, the distribution can comprise a quantile distribution. The imputation model can also indicate that this prediction is based primarily on the known ship type and width, which were provided by the ship.

For some example embodiments, the imputation model of missing value imputation component 218 comprises a Bayes Net, where each node of the net is an independent generalized linear model (GLM) trained using a dataset of the same type that will be used for imputation. The Bayes Net can be structured so that every attribute from the dataset is represented by a single node, and its parent nodes can represent the inputs to the model. Once all the nodes in the net have been trained, the net can be used to generate a larger number of samples from the same distribution. For prediction purposes, the samples can be filtered based on the known attributes of an entity, and the distribution of the missing attribute can be returned as the prediction. For some example embodiments, the GLM nodes are replaced by more complex models.

The strangeness/anomaly component 220 is configured to understand and flag strange or anomalous reported values for attributes of an entity (e.g., moving entity, such as a ship). Depending on the example embodiment, the strangeness/anomaly component 220 uses the imputation model of the missing value imputation component 218 to detect strange/anomalous reported values, or uses an ML model (e.g., Bayesian net) similar to the imputation model of the missing value imputation component 218. A reported value of an attribute can be considered strange or an anomaly if the reported value falls outside the expected distribution, which may be a sign of obfuscation or illegal activity by someone associated with the entity (e.g., ship). Given some reported values of an entity, the strangeness/anomaly component 220 can use an ML model to predict the distribution of another reported value of an attribute of the entity and can check whether the strange/anomalous reported value fits the distribution. Coupled with the explainability of the ML model, the strangeness/anomaly component 220 can inform a customer not only whether a reported value is outside the expected distribution but also why it's unexpected. For example, a ship might be reporting that its length is 200 m. The strangeness/anomaly component 220 can see, based on an ML model, that the length is outside the predicted distribution of lengths based on the other reported attribute values. The strangeness/anomaly component 220 can inform a user of that fact, and the ML model can also show the reason it's being flagged as strange (e.g., primarily because the ship is reporting itself to be a “fishing” type and suggests that either the length is not really 200 m, or else the entity is not really a fishing ship).

For some example embodiments, the entity resolution component 222 comprises features to enable entity resolution. As used herein, entity resolution refers to a process or task configured to determine (e.g., identify or find) data records that refer to the same entity (e.g., same moving entity, commercial owner, destination for moving entities, or other types of entities). For some example embodiments, one or more of predicting movements and trajectory of moving entities, imputing of missing values, and the detecting of anomalies are predicated on evidence collected over a larger connected graph of objects (e.g., entities). For some example embodiments, the entity resolution component 222 generates a knowledge graph of entities through a massive integration of different data sources (e.g., of public and proprietary data sources), where the integration relies on entity resolution as described herein (which is extensible to many data types and can operate in real-time). For example, a ship that reported its length to be 200 m might be registered to a shipping company called “Hai Huang Fleet Co.” This company has a similar name to another shipping company, “Huang Hai Ship Management”, which has recently been put into a U.S. watch list. As it turns out, based on the correlation of ship distributions between the two shipping companies, combined with the similarities between their company registration data, we can infer that the two companies are actually the same, adding to our suspicion that the 200 m-long ship is engaging in anomalous activities.

In some cases, it may be possible to treat strong identifiers (e.g., like MMSI for ships) as trusted primary keys, however in cases where no strong identifiers are available (e.g., as is the case for commercial owners), or when the inputs do not consistently contain strong identifiers (e.g., as is the case for destinations), an expensive comparison operation can be performed. Running such comparisons for all pairs would be very expensive. Additionally, traditional entity resolution pipelines involve many table joins and aggregations, which result in extremely clunky pipelines with little in common between data types.

In comparison, the entity resolution of various example embodiments uses continuous vector representations of complex geospatial data, which allows for the preservation of semantic regularities in the data. In particular, according to some example embodiments, the entity resolution component 222 performs entity resolution by determining whether two data records, and x₂, are the same using a two-stage approach. According to some example embodiments, the two-stage cuts down the number of pairwise comparisons performed by first mapping all data records to a continuous vector space (denoted as vec(x)) and using a nearest-neighbor search (e.g., with dot products) to identify matching candidate records and then, more expensive pairwise comparisons is performed only on the nearest neighbors (e.g., when the nearest neighbors' dot products exceed a certain threshold). For example, during the first stage, the data records can be mapped to a common continuous vector span, vec(x₁) and vec(x₂). Their dot product, vec(x₁)·vec(x₂), can reflect how similar x₁ and x₂ are. If the dot product exceeds a certain threshold, then entity resolution can proceed to a second stage, where a more accurate (but expensive to perform) pairwise comparison is performed on the two data records, x₁ an x₂ (e.g., compare(x₁, x₂)). The output of this pairwise comparison can determine (e.g., indicate) whether x₁ and x₂ are the same. Additionally, the case of matching data records to known entities can be handled similarly; given a data record, x, the entity resolution component 222 can find the k nearest neighbors, xₖ, in the continuous vector space (given that the dot products vec(x)·vec(xₖ) exceed a certain threshold). Thereafter, the entity resolution component 222 can run compare(x, xₖ) for all to decide whether x and xₖ a the same (or which xₖ is the closest match to x). According to various example embodiments, the first stage (mapping data records to a vector space followed by nearest-neighbor search) is a cheap operation to perform (e.g., relative to a pairwise comparison operation) and effectively cuts down the number of expensive pairwise comparison operations that need to be made.

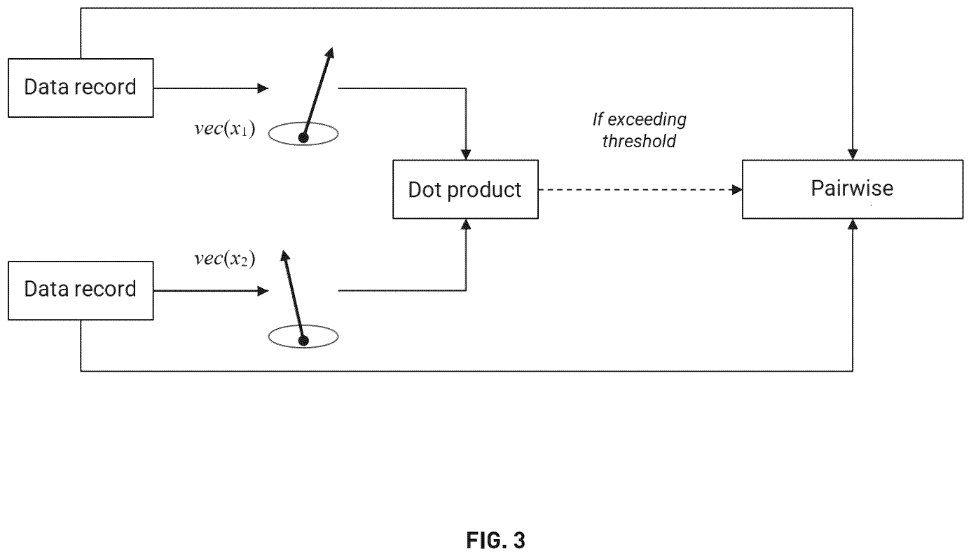

FIG. 3 is a diagram illustrating the two-stage entity resolution approach, in accordance with some example embodiments of the present disclosure. To support the two-stage entity resolution approach, the entity resolution component 222 can implement or otherwise support one or more infrastructure features, which can include the use of quadruples, different application program interfaces (APIs) (examples of which are provided below in Table 2), or both.

As used herein, a quadruple for an entity can refer to a data structure for the entity that is used by an entity resolution process (described herein) to resolve the entity. For some example embodiments, a quadruple for an entity comprises four elements that together represent a specific piece of information about the entity. Examples of these elements could include, without limitation, a time dimension, and various identifiers or attributes relevant to the entity, such as a geographic location, an owner, or other descriptive data. For various example embodiments, a quadruple comprises (Subject, predicate, object) triples with an additional time dimension, which indicates the times at which the triples were asserted. For example, the geospatial moving entity analysis system 122 can assert that: a ship (subject) had a destination (predicate) of port X (object) at time T (time); a gas tanker (subject) declared Maersk (object) as the commercial owner (predicate) at time T (time); and a fishing vessel (subject) was located (predicate) in South China Sea (object) at time T (time).

Example entity resolution processes can include the process of adding a new destination or commercial owner (as described herein). According to some example embodiments, the process of adding a new destination or commercial owner comprises transforming destination or commercial owner entities into a continuous vector and then performing operations like nearest-neighbor searches and pairwise comparisons (to perform entity resolution) on the destination or commercial owner entities. The result of these operations can be stored or represented as a quadruple, which encapsulates a resolved entity's data in a structured format. According to various example embodiments, this structured approach of using quadruples permits for more efficient processing and querying of data within the geospatial moving entity analysis system 122, as it can standardize how information about entities is stored and accessed within the knowledge graph or database of the geospatial moving entity analysis system 122.

The following details various examples of entity resolution operations that can be performed by entity resolution component 222, including adding a new quadruple for a destination entity (also referred to herein as a destination quadruple), adding a new quadruple for a commercial owner entity (also referred to herein as a commercial owner quadruple), adding a new data source for shipping company entities, updating embedding model used for destination entities (also referred to herein as a destination embedding model), adding new ship entities (or some other type of moving entity) and mobile device entities, and linking a mobile device entity to a ship entity (or other type of moving entity). As used herein, nindex can refer to an entity index, flavor can refer to entity type, and findex of n can refer to entity type of nindex n.

TABLE 1
ADDING NEW DESTINATION QUADRUPLE
For ingestion of a new destination quadruple is ingested, the following operations can be
performed.
1. The destination, x, can be transformed into a continuous vector, vec(x), with an ML
model. This transformation can depend on the value of the quadruple, depend on local
contexts (e.g., the current location of the ship), or bot.
2. A nearest-neighbor search can be performed to find up to k vectors, vec(n₁),
. . . , vec(nₖ), that are closest to vec(x)..
3. Pairwise comparisons can be performed on (x, n₁), . . . , (x, nₖ). Broader contexts can
be used here (e.g., the previous destinations of the ship, whether n lies in the predicted
trajectory of the ship, the port volumes of n, etc.).
4. If n is the best match, then a new derived quadruple can be added (e.g., to the
knowledge graph or database) with the value being the resolved nindex of n. This
derived quadruple can be distinct from the original destination quadruple to preserve the
original destination string for further purposes (e.g., revisions of the ML model.
5. If there's no match, then no new quadruple is created.
ADDING NEW COMMERCIAL OWNER QUADRUPLE
For ingestion of a new commercial owner quadruple, the following operations can be
performed.
6. The commercial owner, x, can be transformed into a continuous vector, vec(x), with
an ML model. This transformation can depend on the value of the quadruple, depend on
local contexts (e.g., the flag of the ship), or bot.
7. A nearest-neighbor search can be performed to find up to k vectors, vec(n₁),
. . . , vec(nₖ), that are closest to vec(x).
8. Pairwise comparisons can be performed on (x, n₁), . . . , (x, nₖ). Broader contexts can
be used here (e.g., the sightings of all ships associated with x over the last 12 months,
the company metadata for n, recent news articles about x and n, etc.). For edge cases,
human confirmations can be sed.
9. If is the best match, then a new derived quadruple can be added (e.g., to the
knowledge graph or database) with the value being the resolved nindex of n. This new,
derived quadruple can be distinct from the original commercial owner quadruple to
preserve the original commercial owner string for further purposes (e.g., revisions of the
ML model.
10. If x is a name variation of n, then a determination of whether to keep the name n as
before, or replace the name of n with x, can be rendered. It can be decided that the
name of n is kept as is until it is determined that x is seen often enough in feed.
11. Likewise, add can be added to the nearest-neighbor index for n to facilitate future
matching of n, or rev e vec(n) to be the centroid of all member vectors of the cluster.
12. If no match is found, then a new nindex can be created. The findex of n can be
determined to be a shipping company. The name n can be determined to be x. The
vector vec(x) can be added to the nearest-neighbor index to enable future matching of n.
ADDING NEW DATA SOURCE FOR SHIPPING COMPANIES
For ingestion adding a new data source for shipping companies, the operations of “Adding
new commercial owner quadruple” can be performed with the following modifications.
13. Instead of the “commercial owner” property of a ship, the property of focus can be
the name of a shipping company.
14. Before getting the vector representations, the ML model can be retrained with the
new data source (e.g., “Updating destination embedding model” operation).
15. If the new data source is high quality:
16. the shipping company names from the new data source can be preferred over other
data sources;
17. the vector representations of the shipping companies from the new data source can
be preferred over those data sources;
18. permit multiple nindex's to be matched and merge the existing nindex's together
(instead of forcing each entity to match to at most one existing nindex) - one of the
existing nindex's can be reused for the new entity, and all the rest can be forwarded to
this nindex.
19. If multiple entities from the new data source are matched to the same existing
nindex, the existing entity can be split, depending on whether there's evidence of
overmerge.
UPDATING DESTINATION EMBEDDING MODEL
This update operation can be performed, for example, when a new destination embedding
model is released. The following operations can be performed during the update operation.
20. For each destination quadruple in the knowledge graph (with the original destination
strings, not the resolved nindex's), reperform “Adding new destination quadruple”
operation.
21. Either replace the existing derived quadruples (e.g., with resolved nindex's) with
new ones, or add new derived quadruples (e.g., to the knowledge graph or database)
with a new timestamp, where the timestamp can be useful for tracing the update
operation run for future analysis.
22. If a destination quadruple used to be matched and is now no longer matched, then
either remove the existing derived quadruple, or add a new derived quadruple with an
empty value that indicates that the previous match is no longer valid.
Where multiple models are released, the releases can be batched into a single update
operation job for improved efficiency.
ADDING NEW SHIPS OR MOBILE DEVICES
For adding new ships or mobile devices, the operations of “Adding new commercial
owner quadruple” can be performed with the following modifications (based on the strong
identifiers for ships and mobile devices).
23. The transformation of the strong identifiers to vector representations can be skipped.
24. The use of nearest-neighbor search can be replaced with table lookups.
25. The pairwise comparison can be used as the equality function, and can be performed
synchronously at ingestion time of the new ship or new mobile device.
LINKING MOBILE DEVICES TO SHIPS
For some example embodiments, a batch job is performed to add new links from mobile
devices to ships based on an ML model. The operations of linking mobile devices to ships
can be performed similar to those performed to ingest external data feeds or impute missing
values for which existing quadruples. Depending on the example embodiment, the batch job
can output quadruples with existing nindex's (e.g., similar to imputation), or can output raw
identifiers (e.g., similar to an ingest job). The links can be added to the knowledge graph or
database used by the geospatial moving entity analysis system 122.

The following Table 2 provides a listing of example APIs according to some example embodiments.

TABLE 2

| API | Description |
|---|---|
| vec(findex, | The vec function returns the vector |
| identifier, | representation of a “raw” identifier (e.g., |
| record = None) -> | a destination string, or a commercial |
| vector | owner name) to be matched against the |
| | vector representations of entities of |
| | flavor findex. The vec function can use |
| | additional context in the form of the |
| | data record from which the |
| | raw identifier is extracted. |
| vecs(entity) -> | The vecs function returns the vector |
| list[vector] | representations of an entity, with all of |
| | the entity's latest quadruples available, |
| | including the entity's findex and the |
| | entity's raw identifiers. The function can |
| | return multiple vectors, in case there are |
| | multiple identifiers for a given entity |
| | (such as standardized port codes and |
| | city names). |
| compare(identifier, | The compare function returns true if the |
| entity, record = None, | raw identifier matches the entity. It can |
| cnx = None) -> | also return a confidence score in case |
| (bool, float) | there are multiple matches to consider |
| | and only one of them is to be selected. |
| | Similar to vec, the data record from |
| | which the identifier is extracted can be |
| | provided as context. Broader context can |
| | also be available, which can come in the |
| | form of a database connection (cnx) |
| | with which arbitrary database queries |
| | can be run. |
| update_vecs(entity_ | The update_vecs function can update a |
| vecs, identifier_vec) -> | vector representation of a given entity |
| list[vector] | (entity_vecs) after an identifier |
| | (represented by identifier_vec) has been |
| | merged. Alternatively, this function can |
| | return entity_vecs if one wants to avoid |
| | the vector representations changing |
| | (such as ports and cities). |

To mitigate the expense of performing entity resolution operations and the cascading effect the entity resolution operations can have within the geospatial moving entity analysis system 122 (e.g., impact on missing value imputation, trajectory prediction, and trajectory matching, such as by linking mobile devices to ships), for some example embodiments, entity resolution operations are performed as in batch mode (rather than in a streaming or continuous mode). Alternatively, for some example embodiments, streaming or continuous mode performance of entity resolution operations is used to minimize the reaction time of the geospatial moving entity analysis system 122.

To maintain nindex stability across different process pipelines (e.g., during batch mode entity resolution) of the geospatial moving entity analysis system 122, for some example embodiments, a function is defined that is deterministic and has few collisions. This function can, for example, take the fingerprint of a concatenation of the maximum raw identifier associated with n and the findex (so the nindex's wouldn't collide between entity types or flavors).

Implementation of category identifiers (IDs) assignment can be similar to entity resolution operations, where categories can be treated as entities, the nindex is treated as category IDs, and the raw identifiers of categories can be treated as category strings.

According to some example embodiments, the two-stage approach to entity resolution is extensible to several different data types. While entity resolution for destinations and commercial owners is provided below in greater detail, the two-stage approach to entity resolution by various example embodiments can be adapted to other types of entities.

Destination resolution of some example embodiments can help address errors that might arise when a ship crew member manually enters a destination into an AIS system of a ship when starting a shipping voyage. While many of the entered strings can be standardized port codes or port names that can be easily parsed, many strings can have misspellings (e.g., “EE MUU” is not a correct port code), can have abbreviations (e.g., “ST KITS”), can have extra tokens (e.g., “ITGIT-HARBOUR TOWAGE”), can have extra punctuations (e.g., “ERLENBACH@@@@@@@@@ H”), mention multiple ports in a voyage (e.g., “PACTB>>>>COCTG”), can mention countries (e.g., “SHANGHAICN”), or can be un-parseable (e.g., “0”). These deviations can render the destination resolution task fairly challenging.

According to some example embodiments, destination entity resolution comprises using a character n-gram embedding for mapping spelling variations for port entities to same neighborhoods in a continuous vector space. The training set can comprise destinations from a feed (e.g., a geospatial data feed) coupled with port entities with a closest Levenshtein edit distance, which can be further cleaned up (e.g., by dropping the last word from the destination strings and parsing complex strings like “US\hat{ }0U2Z>0D67” with handcrafted rules). The training algorithm can maximize the log-likelihood of observing the destinations given the closest port entities, while minimizing the log-likelihood of observing the destinations given port entities that were not the same. More regarding various example embodiments of destination entity resolution is described below.

With respect to performing entity resolution of destinations for moving entities (e.g., ship ports, airports, etc.), the entity resolution component 222 can match destinations to a UN/LOCODE dataset, which is a collection of canonical entities for port locations and includes standardized country and location codes, location names (e.g., without diacritics), subdivision codes (e.g., U.S. states), and coordinates. One challenge of entity resolution of destinations is the predominance of spelling variations (e.g., “KUAN TAN” vs “KUANTAN”, “ODUDU TERM” vs “ODUDU TERMINAL”). For various example embodiments, the entity resolution component 222 maps spelling variations for the same entity to the same neighborhood in the continuous vector space. Traditional word embedding techniques represent each word of a vocabulary by a distinct vector, ignoring the internal structure of words. For some example embodiments, the entity resolution component 222 uses an adaptation of character n-gram embedding (e.g., as described by Edizel, B., Piktus, A., Bojanowski, P., Ferreira, R., Grave, E., & Silvestri, F. (2019). Misspelling Oblivious Word Embeddings. arXiv preprint arXiv:1905.09755) that can handle spelling variations in destinations. For example, the entity resolution component 222 can permit words to share parameters by adding character n-gram vectors to the word vectors. For instance, the word “ALEKSANDRA” consists of the following character trigrams: “<AL”, “ALE”, “LEK”, “NDR”, “DRA”, “RA>” (with the special arrow characters representing word boundaries) . . . , This word may share enough character trigrams with the correct spelling “ALEKSANDRIA” (note the extra “I”) such that their vector representations should be somewhat similar. For some example embodiments, the embedding model is further trained with known destination matches and mismatches such that the embedding model learns that the vector representation for “DRA” (“DRA”+“RA>”) should be similar to “DRIA” (“DRI”+“RIA”+“IA>”).

According to some example embodiments, character bigrams are used (e.g., instead of trigrams) for matching destinations when destinations have very short names (e.g., a port code is only 3 or 5 characters long so bigrams can be used in place of trigrams). Additionally, for some example embodiments, an entire destination string is treated as a single word (e.g., omitting spaces) when computing character bigrams or trigrams. This can address the issue of spaces being inserted or omitted in destination strings, which can result in the creation or removal of word boundaries. For instance, “TR SSX” and “TRSSX” will produce the same character bigrams (despite having different words), while “NEW_MANGALORE” and “NEW MANGALORE” will produce slightly different character bigrams (as underscores are kept in the bigrams).

With respect to entity resolution of destinations, the training data used to train embedding models can comprise one or more of the following known matches and mismatches: (1) for all port entities in the UN/LOCODE dataset, us (f(n), f(n)) as positive examples (e.g., when f can be the 2-letter country code, the 3- or 5-letter port code, or the port name without diacritics), and sample 5 negative examples (f(n), f(n′) where n′≠n; and (2) for all destinations x, find the closest f(n) by Levenshtein edit distance in the UN/LOCODE dataset (which can include dropping the last wo from x and rerunning edit distance with some penalty, or parsing complex destinations like “US\hat{ }0U2Z>0D6), use (x, f(n)) as positive examples if their relative edit distance is less than 0.4, and sample 5 negative examples (x, f(n′) where f′(n′)≠f(n).

Each word or character n-gram can be mapped to a multi-dimensional unit vector (e.g., 100-dimensional unit vector). A word can be considered out-of-vocabulary if it occurs less than a threshold number of times (e.g., 8 times) in the training set while all character n-grams are kept. This can result in an embedding that contains a certain number of word (e.g., 205,738 words) and a certain number of character n-grams (e.g., 3,258 character n-grams), each of which has multiple trainable parameters (e.g., 100 trainable parameters), trained on multiple labeled examples (e.g., 2,880,536 labeled examples). For some example embodiments, complete words are removed from the vector representation to improve accuracy; this is based on the fact that words still have their own vector representations in the embedding model and can unnecessarily impact the vector representation of destination entity.

With respect to entity resolution of destinations and the pairwise comparison, entity resolution comprises computing the relative Levenshtein edit distance between a destination and a field of a canonical entity f(n) when f can be the country code, the port code, or the port name.

For some example embodiments, collection of training data for destination entity resolution comprises identifying port names by joining the destinations with ship sightings. This method operates on the understanding that a ship is likely near its original destination when it changes its destination in AIS. Accordingly, whenever there's a destination quadruple for a ship (e.g., a recorded_at field of a quadruple can indicate the last time when a triple was asserted in AIS), the entity resolution component 222 can look up the previous sighting of the ship and map its closest port to the destination. To address the challenge that not all destination changes occur near the destination port, the entity resolution component 222 can find the most likely location of a destination (e.g., Singapore−[SGSIN]) by identifying the sighting of changes from the destination (e.g., from [SGSIN]) with the highest relative probability (e.g., across all ships) based on kernel density estimation. To address the challenge of ports (e.g., SGSIN) that have many terminals with their own port codes, the entity resolution component 222 can merge port data from both UNECE and a geospatial data feed (e.g., so all but 2 type-1 ports with UN/LOCODE would have coordinates). Accordingly, for a given location, the entity resolution component 222 can consider, for example, the k=20 closest ports by haversine distance, and then find the port name with the longest common subsequence with the destination (e.g., with skip penalties) and use that as the closest port. The entity resolution component 222 can repeat this process for all unique destination strings.

The entity resolution component 222 of various example embodiments is configured to handle the challenges of a destination referring to more than one port entity. For example, the USCG AIS encoding guide advises the encoding of both origination and destination in a destination string (e.g., “USCIR>USMSY>USCIR” for a round trip). A destination string can include extra tokens for indicating sub-areas within a port (e.g., official guide for the JP MIZ port), and these entities and tokens can appear in specific sequences. To address this challenge and facilitate matching of a destination to a port by the entity resolution component 222, the entity resolution component 222 can extract a port substring from a destination to perform entity resolution.

In particular, for some example embodiments, the entity resolution component 222 uses sequence labeling to perform named entity recognition (the process of identifying proper names from unstructured text) to extract a port substring from a destination. For instance, given a destination string [USCIR>USMSY], the entity resolution component 222 can break it down into 3 tokens: [“USCIR”, “>”, “USMSY”], and then for each token, decide whether it's part of a port substring. Since the “>” arrow indicates the direction of a voyage, the entity resolution component 222 could prefer extracting the port substring on the right of the arrow rather than the one on the left. The output label sequence could be: [“O”, “O”, “I”], where “O” stands for outside a target named entity, “I” stands for inside.

The entity resolution component 222 of some example embodiments derives training data for the named entity recognition task from sighting-based data. For example, consider the destination string [DUBAI-WATER FRONT] in the dataset that is matched to the port of [DUBAI] by longest common subsequence. This translates into the target label sequence [“I”, “O”, “O”, “O”] where each label is for one token (the dash between “DUBAI” and “WATER” is its own token). Using (token sequence, target label sequence) pairs, the entity resolution component 222 can train a transformer-based model (e.g., with 2 transformer layers with 2 attention heads) for named entity recognition. The embedding layer of this named entity recognition (NER) model can be the same character n-gram-based embedding as described herein (so that NER is resilient to spelling variations). The output layer can be a dense layer whose output dimension is the size of the context window times the number of possible labels (e.g., 2). The outputs can be passed through the SoftMax activation function (e.g., optimized for cross entropy) so that the outputs can be interpreted as probabilities. To extract a port substring from a destination, the entity resolution component 222 can identify the sequence of “I” labels with the largest sum of per-label probabilities. If there's no “I” label, then we extract the entire destination as the port string. The net effect is improved accuracy of destination entity resolution.

To improve precision of destination entity resolution, the entity resolution component 222 of some example embodiments replace the re-ranking of nearest neighbors (by computing the Levenshtein distance between the destination string and the candidate port names) with the relative length of the longest common subsequence (e.g., with skip penalties), multiplied by the cosine similarity between the vector embeddings. Additionally, the entity resolution component 222 of some example embodiments skip all predictions where the relative length of the longest common subsequence is less than 0.6 (to be consistent with how the training data is generated), and skip all predictions where the absolute length of the longest common subsequence is less than 3 (as 3 can be the shortest length of a standardized port code).

For entity resolution of commercial owners (e.g., of a ship), the challenge is to identify commercial owner names that refer to the same entity, which is generally unknown given that there no canonical entities for commercial owners to match against or it's hard to get labeled data for commercial owners. Additionally, commercial owner names generally do not seem to show as many character-level spelling variations as other entities (e.g., destination entities) and the names usually look a lot cleaner (e.g., with proper capitalization). To generate the vector representation of commercial owners, some example embodiments represent the name of a commercial owner as a bag of words weighted by their significance, where the significance of a given word can be modeled by its term frequency (TF) times inverse document frequency (IDF) as follows: where n_{w,x} is the frequency of word w in n e x (usually), N is the total number of names in the database and Why is the number of names in the database containing word w. The TFIDF vectors can then be normalized to unit length. According to some example embodiments, two commercial owners are subsequently considered for pairwise comparison only if the dot product of their respective vectors is at least 0.5.

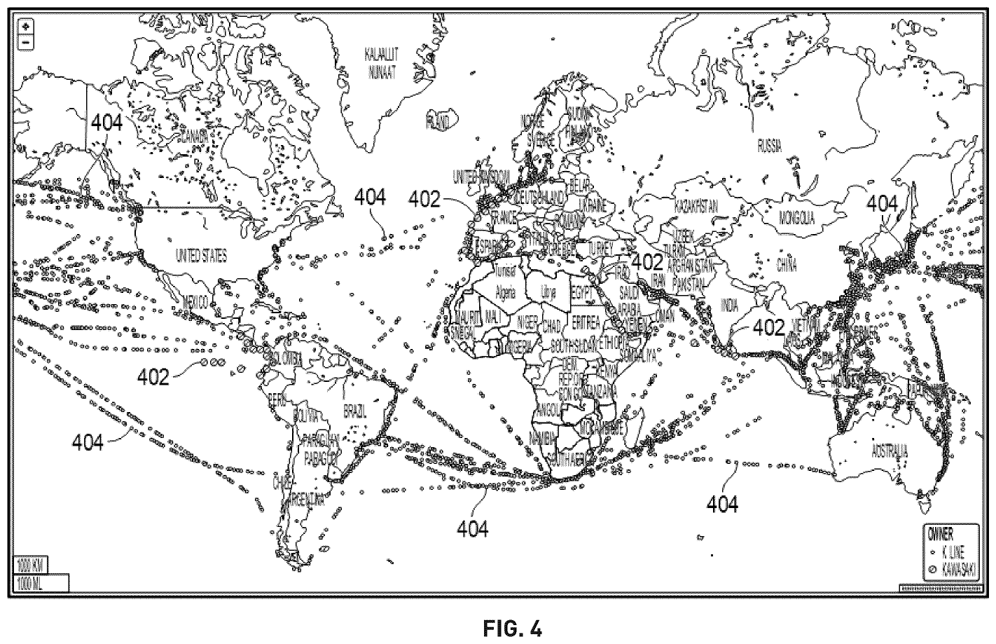

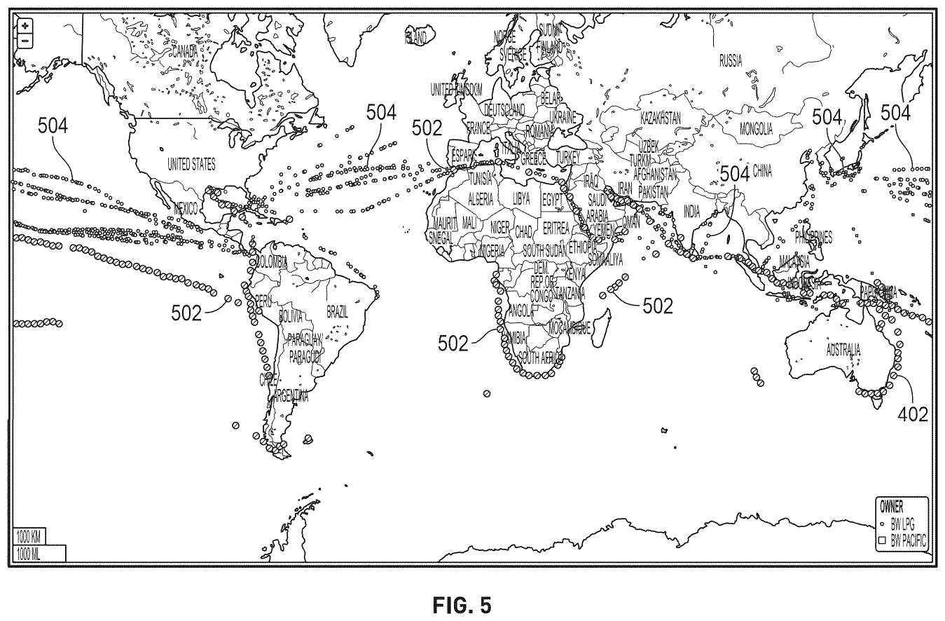

Due to the difficulty in obtaining labeled data for certain types of entities, such as commercial owners of ships, various example embodiments rely on feature engineering to perform pairwise comparison of entities. For instance, FIG. 4 illustrates a comparison of distributions of ship sightings between two commercial owners. Generally, companies tend to be the same if they run similar ship routes and do business in similar parts of the globe. Based on the period (e.g., 1 month) of ship sightings illustrated in FIG. 4, the ship routes for “Kawasaki” (402) are subsumed by the larger network for “K Line” (404), and therefore the two commercial owners are likely to be determined to be the same by the entity resolution component 222. FIG. 5 also illustrates a comparison of distributions of ship sightings between two commercial owners. However, in FIG. 5, “BW LPG” (502) and “BW Pacific” (504) seem to operate in different hemispheres and, therefore, it is less likely for the entity resolution component 222 to consider the two commercial owners to be the same.

Depending on the example embodiment, entity resolution component 222 can quantify the similarity between ship sighting distributions with one or more different measures, which can include a Chi-squared test; a Hausdorff distance; a Kernel density estimation. With respect to a Chi-squared test, the entity resolution component 222 can overlay the world map with a grid (5° by 5° in size), and treat the tiles as mutually exclusive categories in a contingency table. The null hypothesis of the chi-squared test can be that there are no differences between the two categorical variables representing the distributions of ship sighting frequencies relative to the grid, from which the entity resolution component 222 can infer that the commercial owners behind those ship sighting frequencies are the same. With respect to a Hausdorff distance, the entity resolution component 222 can avoid the dependency on size of the grid (unlike Chi-squared test) and can directly measure how close two sets of points are from each other. In particular, the entity resolution component 222 determines that a set is has a close Hausdorff distance to a se X₂ if every point X₁ is close to some point in X₂. Mathematically, d_{H}(X₁, X₂) equals maxₓ_{₁}_{∈X}_{₁}minₓ_{₂}_{∈X}_{₂}d(x₁, x₂) here d is the haversine distance. To recognize the case where a set of points is subsumed by the other, the entity resolution component 222 can (use a modified definition of the symmetric Hausdorff distance) by taking the minimum (instead of the maxi m) of d_{H}(X₁, X₂) and d_{H}(X₂, X₁). With respect to a Kernel density estimation, the entity resolution component 222 can avoid sensitivity to outliers (the Hausdorff distance) and can estimate a (smooth) probability density function given a set of points (say X₂), and turning the similarity measure into the joint probability of observing another set of points (say X₁) given the estimated PDF. Mathematically, P(X₁|X₂) equals

$${\prod }_{{x}_{1} ∈ {X}_{1}} \frac{1}{\vert {X}_{2} \vert} {\sum }_{{x}_{2} ∈ {X}_{2}} K ( d ( {x}_{1} , {x}_{2} ) ) ,$$

where K is the Gaussian kernel with a fixed σ of some example embodiment, the entity resolution component 222 speeds up computation (and to make the similarity more comparable across different sizes of) by replacing X₂ by the k-nearest points from X₂ to X₁ in the above formula (k=10). The entity resolution component 222 then computes the final similarity score by taking the maximum of P(X₁|X₂) and P(X₂|X₁).

According to some example embodiments, the entity resolution component 222 uses one or more AI models (e.g., embedding models) with hyperparameters tuned with validation sets (e.g., dimension of the destination embedding, standard deviation of the Gaussian kernel for ship sightings). Training data for certain AI models, such as one that is used for destination entity resolution, can be based on non-lexical cues, such as last ship sightings with destinations.

The foundation model component 206 is configured to provide, or provide access to, one or more AI models, such as transformers or other generative models, used by the geospatial moving entity analysis system 122. One or more of the AI models accessed through the foundation model component 206 can represent foundational (generative) models used by the geospatial moving entity analysis system 122. As described herein, a core feature of some AI models (e.g., transformers or other generative models) used by the geospatial moving entity analysis system 122 is treating any given spatiotemporal/geospatial location as a “token,” and given a sequence of previous location tokens (e.g., a spatial “sentence”), the AI model can predict the next spatial sentence (e.g., a spatial sequence (location) forecast or prediction of where the moving entity is heading). In particular, an AI model used by the geospatial moving entity analysis system 122 can be configured to receive as input one or more tokens (e.g., a sequence of tokens) and generate (e.g., output) a sequence of one or more location tokens for the moving entity based on the input, where the outputted sequence of one or more location tokens can represent a spatiotemporal/geospatial sentence for the moving entity that forecasts or predicts where the moving entity may be heading after (e.g., from) the last location token inputted to the AI model. Accordingly, one or more of the AI models accessed through the foundation model component 206 can be trained, fine-tuned, or otherwise configured to receive as input a sequence of location tokens, and to output (e.g., generate) a sequence of location tokens in response to the input. The sequence of location tokens outputted by an AI model can represent a spatial sequence (location) forecast or prediction.

For some example embodiments, a location token-based AI model (also referred to herein as a geospatial AI model) is similar to a non-location-token-based AI model that generates the next word in a sentence given a context window of previous words, but the location-token-based AI model generates the next geolocation (e.g., represented by a location token) in a spatial “sentence” given a context window of previous geolocations (e.g., previous location tokens). A location token-based AI model can be pre-trained on one or more bodies of geolocation or movement data (e.g., unannotated geolocations and movements), and can be pre-trained with self-supervision techniques (rather than with task-specific supervision), such as masked autoencoders for teaching the model generalizable geospatial knowledge that would be useful in downstream tasks. The pre-training causes the location token-based AI model to be taught generalizable geospatial knowledge, which could be useful in downstream tasks (e.g., trajectory prediction, trajectory matching, geospatial data cleansing, anomaly detection, and the like).

According to various example embodiments, a trajectory of a moving entity is “tokenized” in such a way that each location “token” can have a semantic meaning like a word in a sentence. Location tokens with similar meanings can have similar representations in a geospatial model and vice versa, similar to word embeddings of similar and dissimilar words. For example, while a cargo ship moving in full speed in the middle of the Indian ocean could have a similar location token (e.g., spatial token) representation as a cargo ship moving in the middle of the Pacific ocean, however, the cargo ship can show a distinct representation when it reaches its destination and gets ready to dock. These location tokens (e.g., spatial tokens) can be grouped into a spatial “sentence” for describing a longer trajectory or voyage (e.g. a cargo ship on its normal trading route from port A through canal B to port C).

A location token-based AI model of an embodiment can be joined with a pre-trained large language model (LLM) to form a multimodal AI model (e.g., multimodal foundational model) that enables joint modeling of geospatial concepts and natural language expressions commonly used to describe them. For some example embodiments, the multimodal AI model is trained on large corpora of arbitrarily interleaved text and geolocations to ground natural language expressions on geospatial tokens.

An AI model can be fine-tuned to be used on one or more downstream tasks, such as trajectory prediction, trajectory matching, geospatial data cleansing, anomaly detection, and the like. some example embodiments achieve large gains on one or more downstream tasks by leveraging generalizable geospatial knowledge acquired through pre-training on large amounts of unannotated data. As an AI model (e.g., foundational model) reaches a certain scale (e.g. billions of model parameters trained on hundreds of billions of location tokens), the AI model may acquire few-shot learning capabilities which can allow it to handle novel geospatial tasks with only a handful of in-context training examples.

To increase the precision of spatial sequence (location) forecasting or predictions (and perhaps at a fraction of training cost compared to unsupervised or self-supervised training of an AI model), an AI model of some example embodiments is provided assess to one or more external symbolic knowledge bases for corroboration of facts. A simple example of this is the alignment of ship trajectory predictions with coastlines and waterways extracted from symbolic GIS systems to avoid impossible movements. More generally, an AI model of some example embodiments is integrated with a knowledge graph of interrelated entities and facts (e.g., geo entities, vessel metadata, company relationships, sanction statuses, and the like) to deliver highly accurate, explainable and verifiable forecasts/predictions suitable for critical decision making.

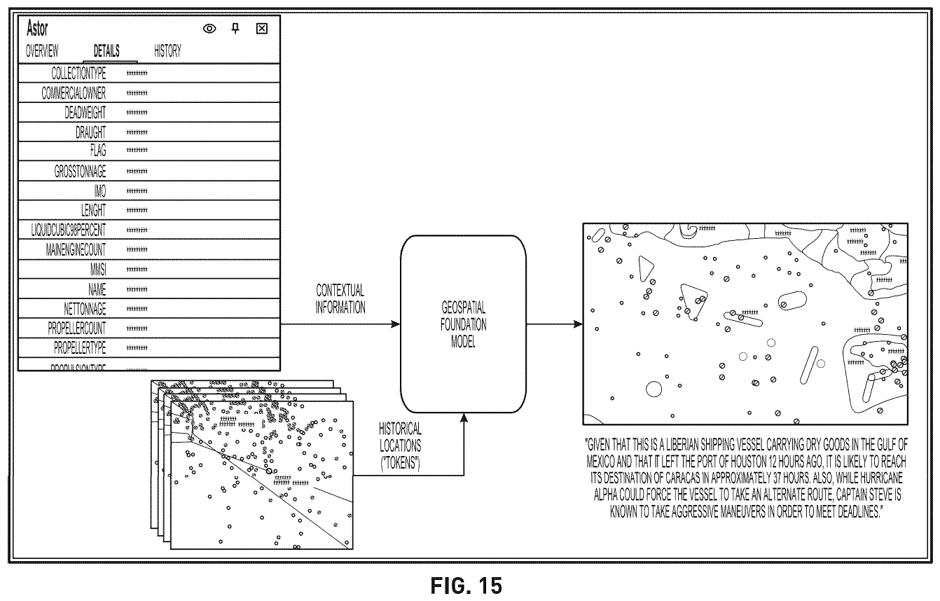

FIG. 15 illustrates how contextual information regarding a moving entity, in combination with historical locations of the moving entity, can enable a geospatial foundation model (e.g., provided by the foundation model component 206) to generate a spatial sequence (location) prediction for the moving entity, and can further provide an explanation of the prediction.

The spherical geometry component 208 is configured to support geographical modeling in the geospatial moving entity analysis system 122 using a new spherical geometry on the surface of spheres, where lines are always defined as the shortest great circle arc. The spherical geometry component 208 can permit the possibility of directional lines to cover where there is a longer great circle arc. Overall, the new spherical geometry supported by spherical geometry component 208 can be used to implement three-dimensional spatial data structures for accurate division of space. Aspects of the new spherical geometry can be implemented using M-Tree or another type of spatial data structure. As used herein, a spatial data structures can comprise a data structure that organizes objects (e.g., entities) by their positions in a defined space (e.g., the defined space being a surface of a sphere when using spherical geometry). Additionally, they don't have to be in 3D. The geographical modeling provided via the spherical geometry component 208 can permit the geospatial moving entity analysis system 122 to model current locations, movements, and intersections with respect to moving entities. Various operations that the spherical geometry component 208 can support include geo position look-ups, such as find the nearest entity (e.g., “Are these boats buddies?”), find the nearest line (e.g., “What river is this ship on?”), find the intersection between two lines (e.g., “Does this ship's path intersect with a coastline?”); find the intersection between a line and a plane in 3-space; and variants to find all intersections between a million lines and a plane (e.g., “What ships passed through a particular region on the surface of the earth?”). Various operations that the spherical geometry component 208 can support also include: projecting movements of a ship into the future (e.g., “Extrapolate possible trajectories”); inferring movements of a ship to avoid an island (e.g., “Infer path between two sightings”); basic 3D rotation/translation/projection; and produce Cartesian coordinates for a graphical user interface provided by the geospatial moving entity analysis system 122. The data structures used by spherical geometry component 208 can include: HyperPoint (for Lat, Lon, Time, and Altitude); HyperLine (for HyperPoint_{Start}, HyperPoint_{End}); HyperRect (for Lat₁, Lon₁, Lat₂, Lon₂, Time₁, Time₂); Movement (which is a HyperLine); and a M-Tree (for an entire world full of Movements). For a Cartesian alternative, HyperPoint can be used for Y, Z, Time, and HyperRect can be used for X₁, Y₁, Z₁, X₂, Y₂, Z₂, Time₁, Time₂.

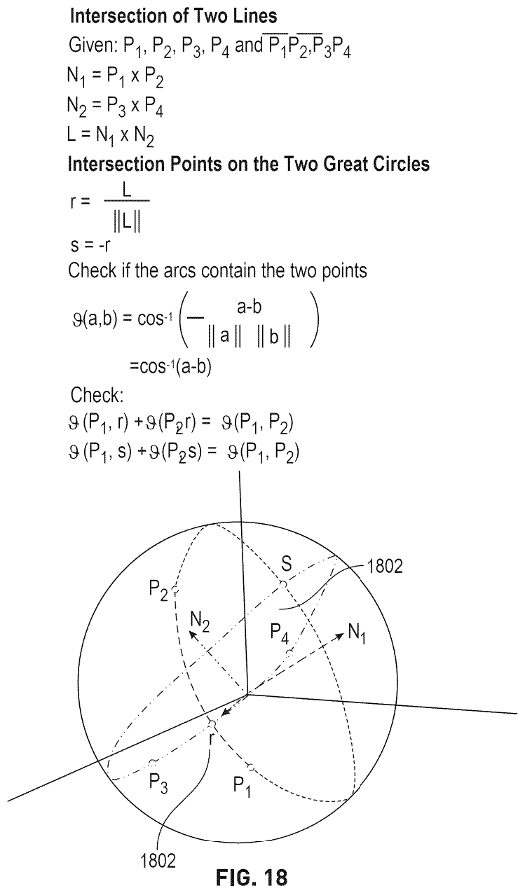

For some example embodiments, the new spherical geometry supported by the spherical geometry component 208 provides spherical coordinates, where: a Great Circle is a cross-section of the sphere with a radius of the sphere (R) (e.g., can be uniquely defined by two points on a sphere unless two points are identical or antipodal); a Point is defined by (Latitude, Longitude, Altitude); a Line is the shortest great circle arc defined by a start and an end point; and a Rectangle is a bounding region defined by a bottom left point and a upper right point. The spherical coordinate system is illustrated in FIG. 18. According to various example embodiments, the spherical geometry component 208 can use both coordinates and can use altitude for aircraft or tunnels; can use Cartesian coordinates (x, y, z) for computation and Spherical coordinates for building tree data structures (e.g., a M-Tree, a K-d Tree, and a QuadTree); and can use new geometry of latitude and Great Circles.

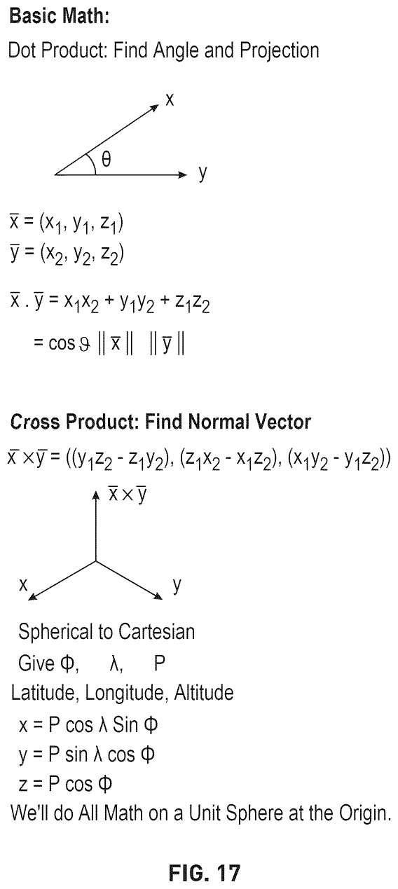

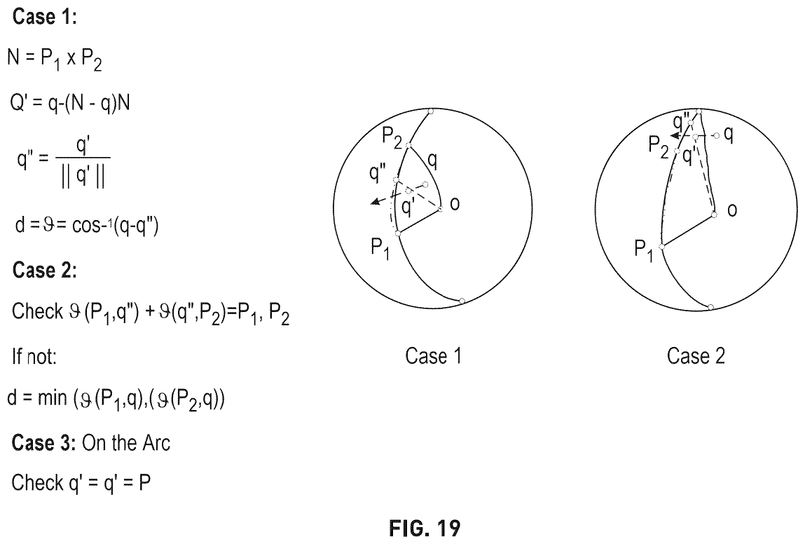

With respect to the math of the new spherical geometry, the basic math of finding a dot product and cross product is illustrated in FIG. 17. The math for the intersection of two lines and intersection points on two Great Circles is illustrated in FIG. 18. In FIG. 18, points 1802 are on the same line. FIG. 19 illustrates example cases for finding the closest point on the line to a point, based on the new spherical geometry described herein, given P₁, P₂, P₁P₂ q, and center O.

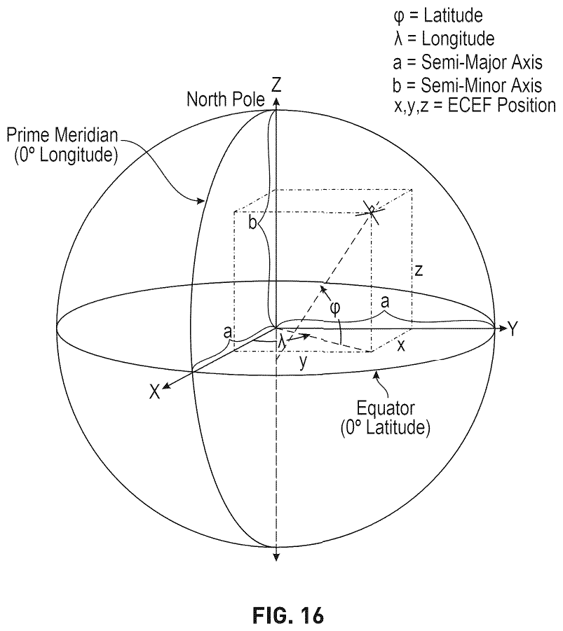

FIG. 16 illustrates different ways a location on the globe can be represented, including: latitude and longitude; X+Y+Z from center (“Cartesian”); and Spherical/Geodetic−φ, λ, h.

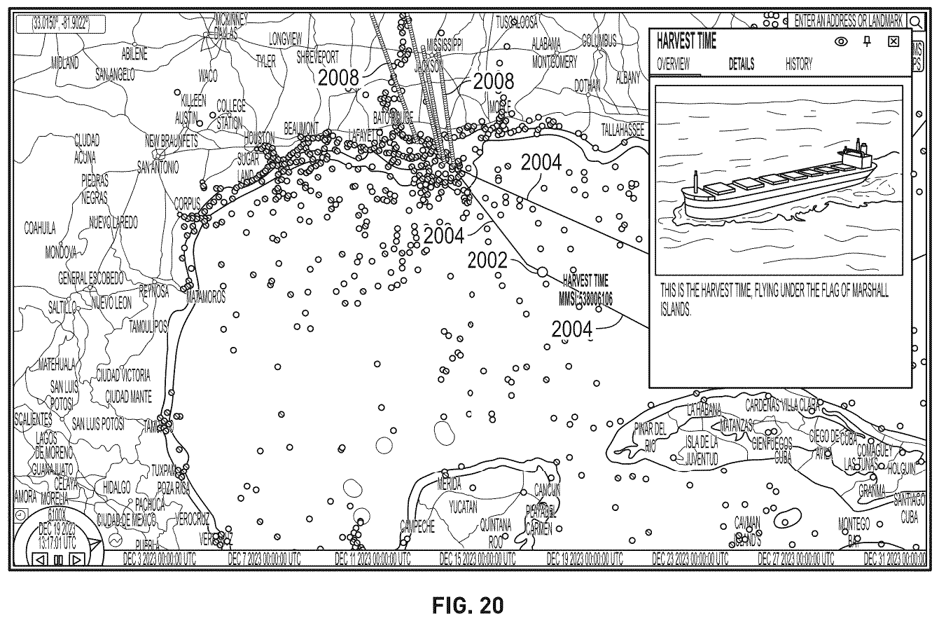

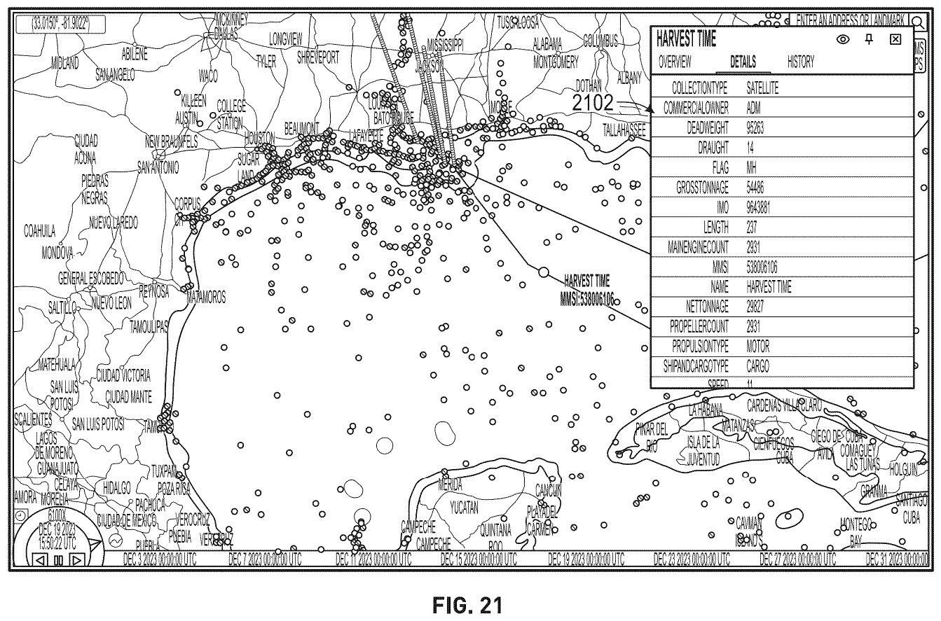

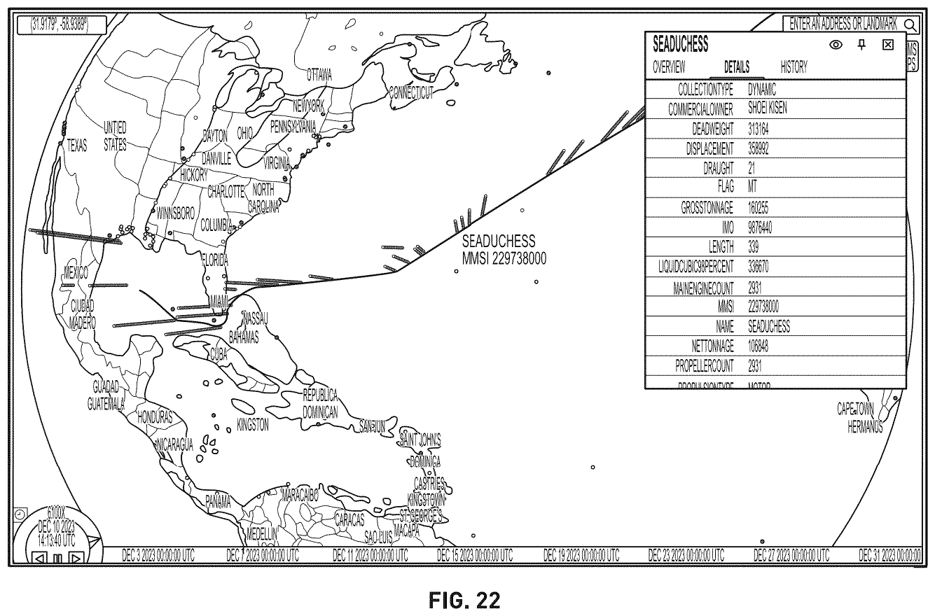

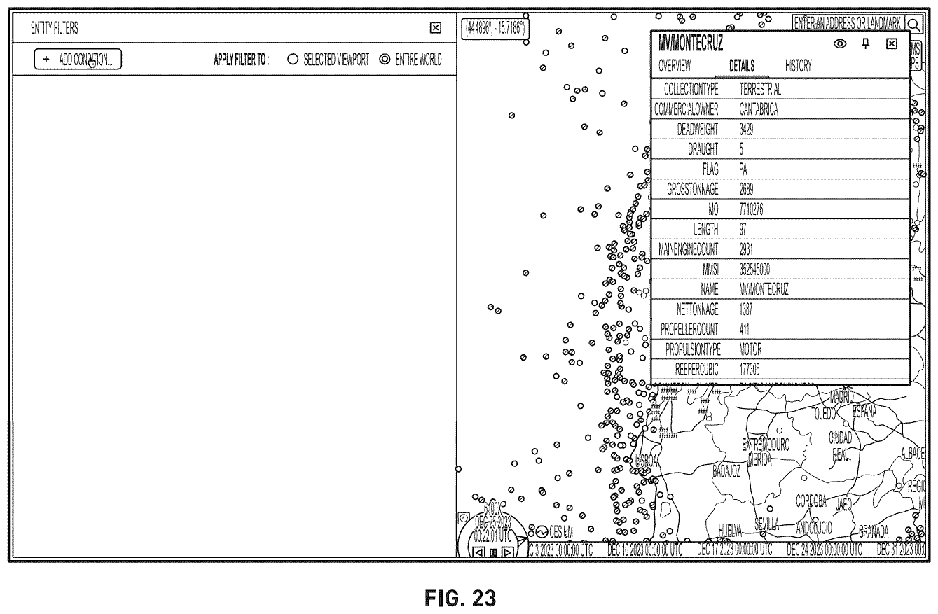

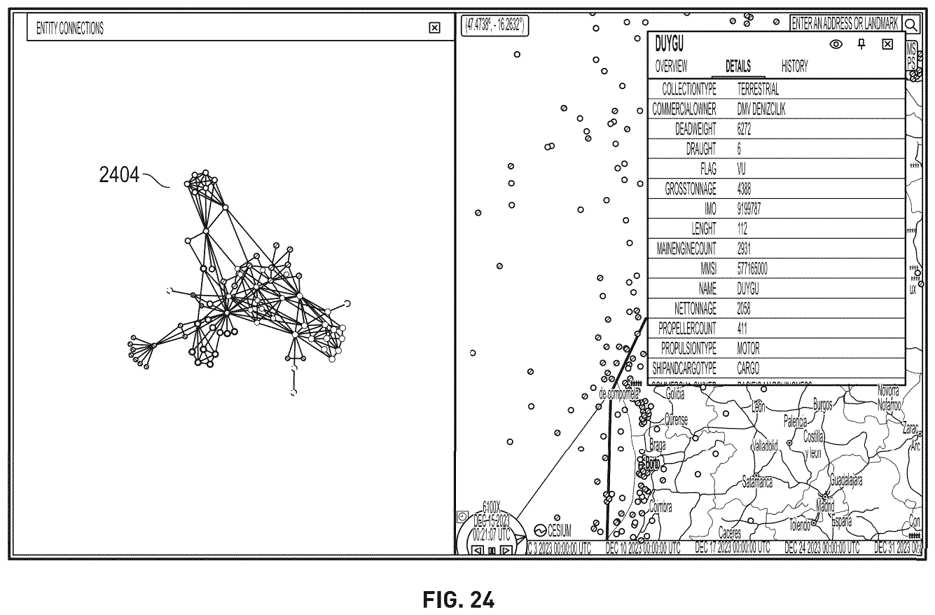

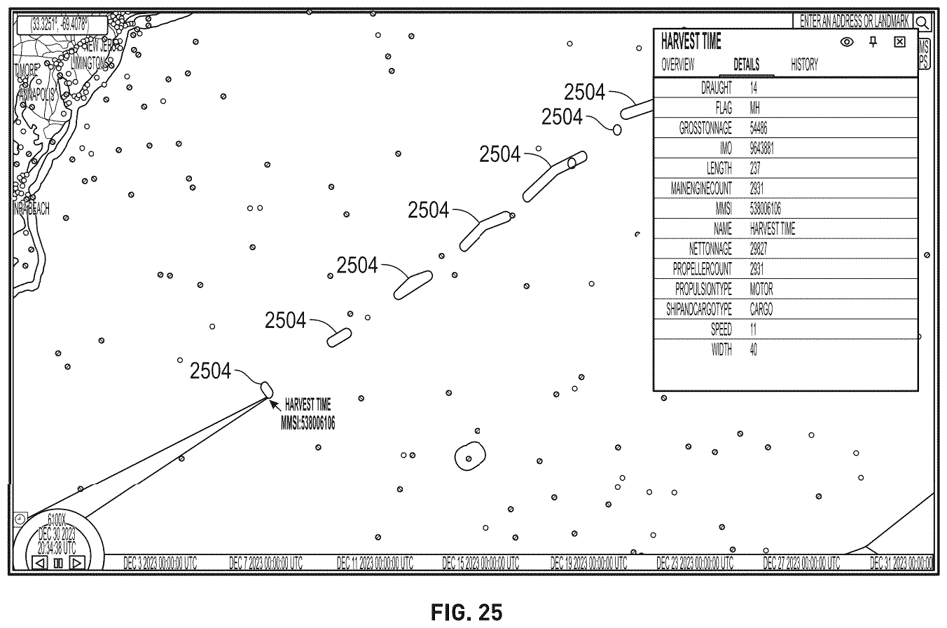

The graphical user interface component 212 is configured to generate (or support generation of) various graphical user interfaces that enable a user of the geospatial moving entity analysis system 122 to access one or more of the geospatial moving entity analysis system 122's features (e.g., inference features) and to review the geospatial moving entity analysis system 122's generated output. Examples of the graphical user interfaces include, without limitation, those illustrated by FIG. 4, FIG. 5, FIG. 20, FIG. 21, FIG. 22, FIG. 23, FIG. 24, and FIG. 25.

FIG. 20 illustrates an example graphical user interface that illustrates various moving entities, specifically ships, in accordance with various example embodiments of the present disclosure. In the graphical user interface, information regarding a selected ship 2002 (named “Harvest Time”) is provided with a past movement (represented by lines 2004). The spikes 2008 locations where the selected ship 2002 was observed or reported its location.

FIG. 21 illustrates the same example graphical user interface as FIG. 20 but with the information 2102 for the selected ship 2002 providing detailed information (e.g., different attribute values) regarding the selected ship.

FIG. 22 illustrates an example graphical user interface that displays where a selected ship reports its location multiple times during its journey. As described herein, the location reports can be represented by spikes within the graphical user interface.

FIG. 23 illustrates an example graphical user interface that includes a filter sub-interface, which can permit a user to apply a filter to moving entities (e.g., ships) displayed within the graphical user interface. As shown, a user can apply one or more filters (or conditions) to filter out moving entities from being displayed in the graphical user interface.

FIG. 24 illustrates an example graphical user interface that includes a sub-interface displaying a visual representation 2404 of connections between various entities of different types (e.g., moving entities like ships, commercial owners, fleets, etc.).

FIG. 25 illustrates an example graphical user interface that displays predicted trajectories for a selected ship (“Harvest Time”) over time. As shown in FIG. 25, the predicted trajectories are represented by the shaded regions 2504.

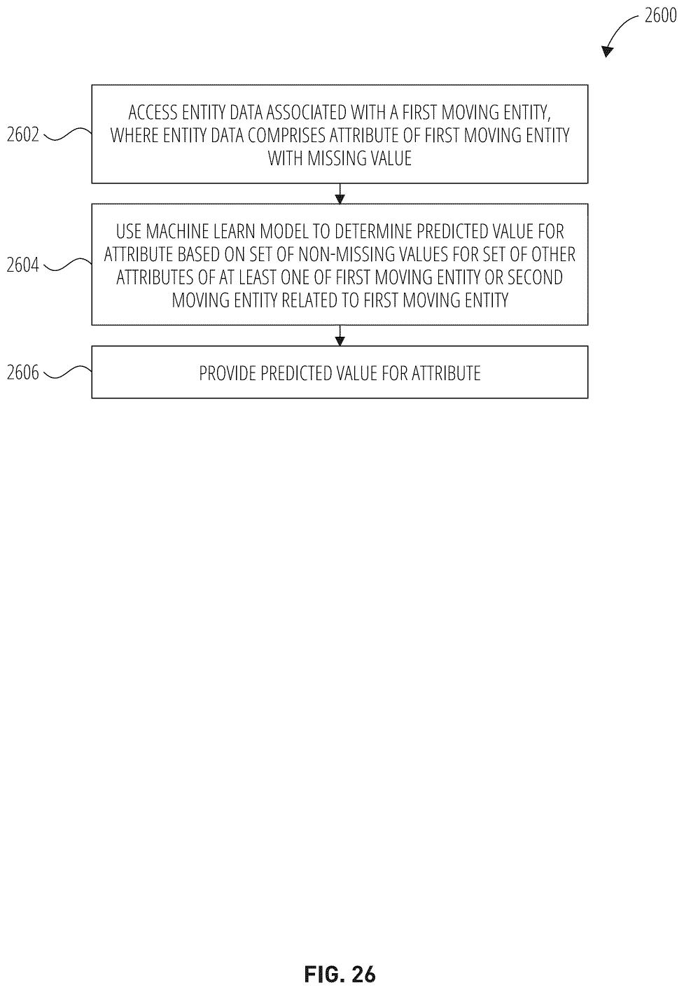

FIG. 26 is a flowchart illustrating an example method 2600 for imputing a missing value of an attribute of a moving entity, according to various example embodiments of the present disclosure. It will be understood that example methods described herein can be performed by a device, such as a computing device executing instructions of a geospatial moving entity analysis system (e.g., 100 or 200), in accordance with some example embodiments. Additionally, example methods described herein can be implemented in the form of executable instructions stored on a computer-readable medium or in the form of electronic circuitry. For instance, the operations of method 2600 can be represented by executable instructions that, when executed by a processor of a computing device, cause the computing device to perform the method. Depending on the example embodiment, an operation of an example method described herein can be repeated in different ways or involve intervening operations not shown. Though the operations of example methods may be depicted and described in a certain order, the order in which the operations are performed may vary among embodiments, including performing certain operations in parallel. An operation of any of method 2600 (or another method described herein) may be performed by a hardware processor (e.g., central processing unit or graphics processing unit) of a computing device (e.g., desktop, server, etc.).

At operation 2602, a hardware processor accesses, by one or more hardware processors, entity data associated with a first moving entity, where the entity data comprises an attribute of the first moving entity with a missing value. Depending on the example embodiment, the first moving entity can comprise one of a ship, an aircraft, an automotive vehicle, or a mobile device. Additionally, depending on the example embodiment, the attribute can comprise one of a location, a speed, a heading, a type, and an ownership (e.g., status or owner name) of the first moving entity. For some example embodiments, at least one attribute of the set of other attributes is one that is reported by the first moving entity. For example, where the first moving entity is a ship, the at least one attribute being reported by the ship (e.g., via AIS) can include the ship's location, flag, length, width, draught, ship type, and other similar attributes. Other attributes can also be considered can be dependent on the type of moving entity being analyzed.

For operation 2604, the hardware processor uses a machine learning model to determine a predicted value for the attribute based on a set of non-missing values for a set of other attributes of (e.g., associated with) at least one of the first moving entity or a second moving entity related to the first moving entity. In particular, the hardware processor can use the machine learning model to generate output data based on input data that comprises the set of non-missing values. For example, where the first moving entity is a first ship, the set of non-missing values for the set of other attributes of the first ship (or another ship related to the first moving entity) can comprise one or more of the following known (e.g., reported) attribute values: a ship's location; a ship's flag; a ship's length; a ship's width, a ship's draught; and a ship's ship type. The output data generated can comprise one or more relevant values of one or more other attributes that lead the machine learning model to determine the predicted value. Additionally, the output data generated can comprise an explanation of a given imputation (e.g., of a missing value) by sharing the values of other attributes that lead to the predicted value for the attribute that is missing a value. For some example embodiments, operation 2604 comprises determining an expected distribution of values that are considered within a predicted range for the missing value. For example, the predicted value can be for the first ship's length, which might be missing or reported as 0 by the first ship. During operation 2604, the hardware processor can use the machine learning model to determine a predicted value of 100 m, and determine that the expected distribution of lengths for the first ship is a normal distribution with a mean of 100 and a standard deviation of 10. With respect to an explanation, the machine learning model can indicate that the prediction value is based primarily on the first ship's known ship type and width (e.g., as reported by the first ship).

The machine learning model used can be trained on one or more values of one or more other attributes reported by the first moving entity having the missing value. For some example embodiments, the machine learning model comprises a Bayesian Network, where an individual node of the Bayesian Network comprises an independent generalized linear model (GLM). As described herein, the Bayes Net can be structured so that every attribute from a training dataset is represented by a single node, and its parent nodes can represent the inputs to the model. Once all the nodes in the net have been trained, the net can be used to generate a larger number of samples from the same distribution. For prediction purposes, the samples can be filtered based on the known attributes of an entity, and the distribution of the missing attribute can be returned as the prediction. For some example embodiments, the GLM nodes are replaced by more complex models. Alternatively, or additionally, the machine learning model used can comprise a non-linear model (e.g., a Bayesian Network where the individual nodes of the network are non-linear models, such as GNMs or neural networks), or a neural network (e.g., an end-to-end neural network such as a recurrent neural network or a transformer).

At operation 2606, the hardware processor provides the predicted value for the attribute. As described herein, one or more other components of a geospatial moving entity analysis system can be provided with and use the predicted value to implement their respective analysis features. For instance, the provided predicted value can be used by a geospatial moving entity analysis system (e.g., by strangeness/anomaly component 220) to detect when the first moving entity is reporting strange or anomalous attribute values (e.g., via AIS).

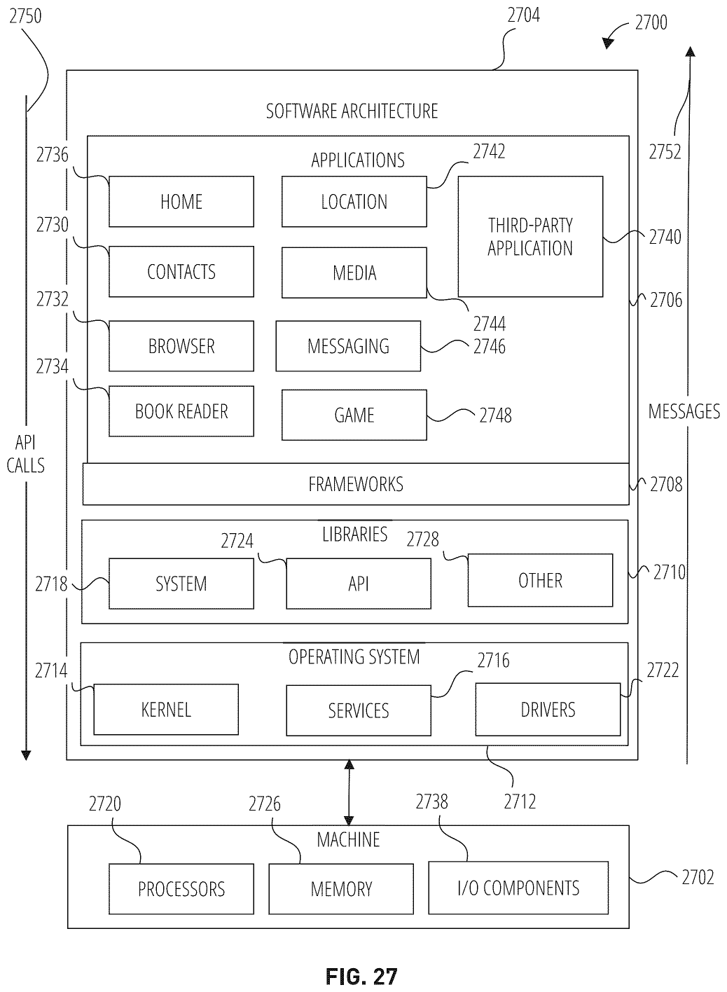

FIG. 27 is a block diagram 2700 illustrating a software architecture 2704, which can be installed on any one or more of the devices described herein. The software architecture 2704 is supported by hardware such as a machine 2702 that includes processors 2720, memory 2726, and I/O components 2738. In this example, the software architecture 2704 can be conceptualized as a stack of layers, where each layer provides a particular functionality. The software architecture 2704 includes layers such as an operating system 2712, libraries 2710, frameworks 2708, and applications 2706. Operationally, the applications 2706 invoke API calls 2750 through the software stack and receive messages 2752 in response to the API calls 2750.

The operating system 2712 manages hardware resources and provides common services. The operating system 2712 includes, for example, a kernel 2714, services 2716, and drivers 2722. The kernel 2714 acts as an abstraction layer between the hardware and the other software layers. For example, the kernel 2714 provides memory management, Processor management (e.g., scheduling), component management, networking, and security settings, among other functionalities. The services 2716 can provide other common services for the other software layers. The drivers 2722 are responsible for controlling or interfacing with the underlying hardware. For instance, the drivers 2722 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 2710 provide a low-level common infrastructure used by the applications 2706. The libraries 2710 can include system libraries 2718 (e.g., C standard library) that provide functions such as memory allocation functions, string manipulation functions, mathematic functions, and the like. In addition, the libraries 2710 can include API libraries 2724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 2710 can also include a wide variety of other libraries 2728 to provide many other APIs to the applications 2706.

The frameworks 2708 provide a high-level common infrastructure used by the applications 2706. For example, the frameworks 2708 provide various graphical user interface (GUI) functions, high-level resource management, and high-level location services. The frameworks 2708 can provide a broad spectrum of other APIs that can be used by the applications 2706, some of which may be specific to a particular operating system or platform.

In some examples, the applications 2706 may include a home application 2736, a contacts application 2730, a browser application 2732, a book reader application 2734, a location application 2742, a media application 2744, a messaging application 2746, a game application 2748, and a broad assortment of other applications such as a third-party application 2740. The applications 2706 are programs that execute functions defined in the programs. Various programming languages can be employed to create one or more of the applications 2706, structured in a variety of manners, such as object-oriented programming languages (e.g., Objective-C, Java, or C++) or procedural programming languages (e.g., C or assembly language). In a specific example, the third-party application 2740 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2740 can invoke the API calls 2750 provided by the operating system 2712 to facilitate functionality described herein.

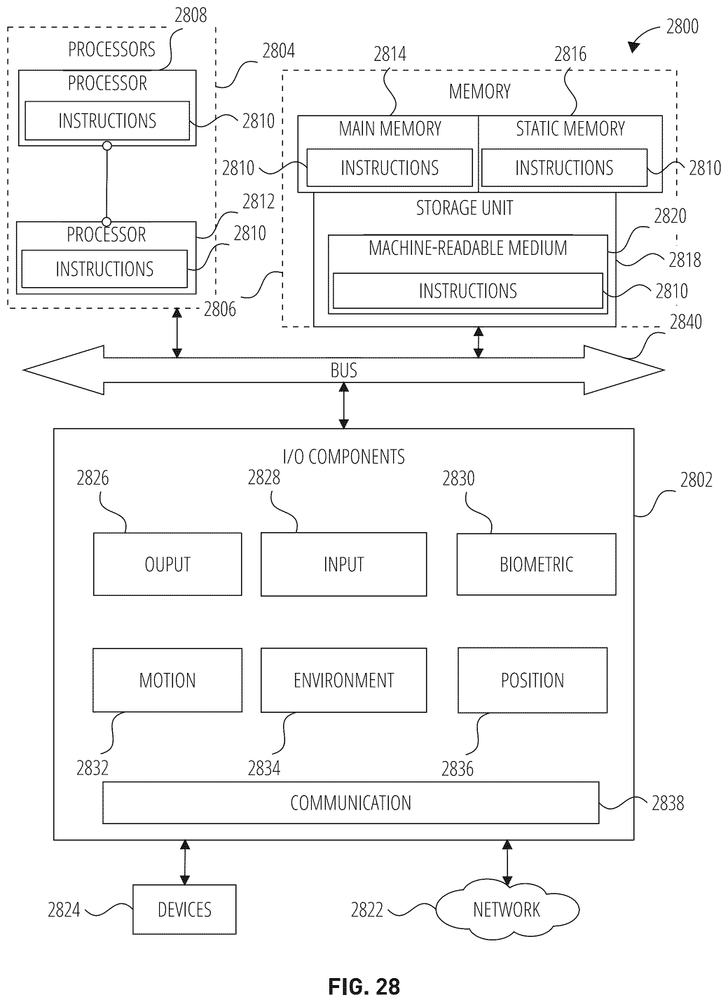

FIG. 28 is a diagrammatic representation of the machine 2800 within which instructions 2810 (e.g., software, a program, an application, an applet, an app, or other executable code) for causing the machine 2800 to perform any one or more of the methodologies discussed herein may be executed. For example, the instructions 2810 may cause the machine 2800 to execute any one or more of the methods described herein. The instructions 2810 transform the general, non-programmed machine 2800 into a particular machine 2800 programmed to carry out the described and illustrated functions in the manner described. The machine 2800 may operate as a standalone device or be coupled (e.g., networked) to other machines. In a networked deployment, the machine 2800 may operate in the capacity of a server machine or a client machine in a server-client network environment, or as a peer machine in a peer-to-peer (or distributed) network environment. The machine 2800 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2810, sequentially or otherwise, that specify actions to be taken by the machine 2800. Further, while a single machine 2800 is illustrated, the term “machine” may include a collection of machines that individually or jointly execute the instructions 2810 to perform any one or more of the methodologies discussed herein.

The machine 2800 may include processors 2804, memory 2806, and I/O components 2802, which may be configured to communicate via a bus 2840. In some examples, the processors 2804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 2808 and a Processor 2812 that execute the instructions 2810. The term “Processor” is intended to include multi-core processors that may comprise two or more independent processors (sometimes referred to as “cores”) that may execute instructions contemporaneously. Although FIG. 28 shows multiple processors 2804, the machine 2800 may include a single processor with a single core, a single processor with multiple cores (e.g., a multi-core processor), multiple processors with a single core, multiple processors with multiples cores, or any combination thereof.

The memory 2806 includes a main memory 2814, a static memory 2816, and a storage unit 2818, both accessible to the processors 2804 via the bus 2840. The main memory 2806, the static memory 2816, and storage unit 2818 store the instructions 2810 embodying any one or more of the methodologies or functions described herein. The instructions 2810 may also reside, wholly or partially, within the main memory 2814, within the static memory 2816, within machine-readable medium 2820 within the storage unit 2818, within the processors 2804 (e.g., within the processor's cache memory), or any suitable combination thereof, during execution thereof by the machine 2800.

The I/O components 2802 may include various components to receive input, provide output, produce output, transmit information, exchange information, or capture measurements. The specific I/O components 2802 included in a particular machine depend on the type of machine. For example, portable machines such as mobile phones may include a touch input device or other such input mechanisms, while a headless server machine will likely not include such a touch input device. The I/O components 2802 may include many other components not shown in FIG. 28. In various examples, the I/O components 2802 may include output components 2826 and input components 2828. The output components 2826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 2828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2802 may include biometric components 2830, motion components 2832, environmental components 2834, or position components 2836, among a wide array of other components. For example, the biometric components 2830 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 2832 include acceleration sensor components (e.g., accelerometer), gravitation sensor components, rotation sensor components (e.g., gyroscope). The environmental components 2834 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2836 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2802 further include communication components 2838 operable to couple the machine 2800 to a network 2822 or devices 2824 via respective coupling or connections. For example, the communication components 2838 may include a network interface Component or another suitable device to interface with the network 2822. In further examples, the communication components 2838 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2824 may be another machine or any of a wide variety of peripheral devices (e.g., a peripheral device coupled via a USB).

Moreover, the communication components 2838 may detect identifiers or include components operable to detect identifiers. For example, the communication components 2838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 2838, such as location via Internet Protocol (IP) geolocation, location via Wi-Fi® signal triangulation, or location via detecting an NFC beacon signal that may indicate a particular location.

The various memories (e.g., main memory 2814, static memory 2816, and/or memory of the processors 2804) and/or storage unit 2818 may store one or more sets of instructions and data structures (e.g., software) embodying or used by any one or more of the methodologies or functions described herein. These instructions (e.g., the instructions 2810), when executed by processors 2804, cause various operations to implement the disclosed examples.

The instructions 2810 may be transmitted or received over the network 2822, using a transmission medium, via a network interface device (e.g., a network interface component included in the communication components 2838) and using any one of several well-known transfer protocols (e.g., hypertext transfer protocol (HTTP)). Similarly, the instructions 2810 may be transmitted or received using a transmission medium via a coupling (e.g., a peer-to-peer coupling) to the devices 2824.

Described implementations of the subject matter can include one or more features, alone or in combination as illustrated below by way of examples.

Example 1 is a system comprising: a memory storing instructions; and a hardware processor communicatively coupled to the memory and configured by the instructions to perform operations comprising: accessing entity data associated with a first moving entity, the entity data comprising an attribute of the first moving entity with a missing value; using a machine learning model to determine a predicted value for the attribute based on a set of non-missing values for a set of other attributes of at least one of the first moving entity or a second moving entity related to the first moving entity, the using of the machine learning model to determine the predicted value for the attribute comprising determining an expected distribution of values that are considered within a predicted range for the missing value; and providing the predicted value for the attribute.

In Example 2, the subject matter of Example 1 includes, wherein the using of the machine learning model to determine the predicted value for the attribute based on the set of non-missing values for the set of other attributes of the first moving entity comprises: using the machine learning model to generate output data based on input data that comprises the set of non-missing values.

In Example 3, the subject matter of Example 1-2 includes, wherein the output data comprises one or more relevant values of one or more other attributes that lead the machine learning model to determine the predicted value.

In Example 4, the subject matter of Examples 1-3 includes, wherein the machine learning model is trained on one or more values of one or more other attributes reported by the first moving entity having the missing value.

In Example 5, the subject matter of Examples 1-4 includes, wherein the machine learning model comprises a Bayesian Network, and wherein an individual node of the Bayesian Network comprises an independent generalized linear model (GLM).

In Example 6, the subject matter of Examples 1-5 includes, wherein the machine learning model comprises a non-linear model.

In Example 7, the subject matter of Examples 1-6 includes, wherein the machine learning model comprises a neural network.

In Example 8, the subject matter of Examples 1-7 includes, wherein at least one attribute of the set of other attributes is reported by the first moving entity.

In Example 9, the subject matter of Examples 1-8 includes, wherein the attribute comprises one of a location, a speed, a heading, a type, and an ownership of the first moving entity.

In Example 10, the subject matter of Examples 1-9 includes, wherein the first moving entity comprises one of a ship, an aircraft, or an automotive vehicle.

In Example 11, the subject matter of Examples 1-10 includes, wherein the first moving entity comprises a mobile device.

Example 12 is a machine-storage medium comprising instructions that, when executed by a processing device, cause the processing device to perform operations to implement any of Examples 1-11.

Example 13 is a method to implement any of Examples 1-11.

### Glossary

“Carrier Signal” refers to any intangible medium capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In some examples, the processors or processor-implemented components may be distributed across a number of geographic locations.

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines and/or data. The term includes solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium”, “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Module” refers to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “signal medium” may o include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A system comprising:
a memory storing instructions; and
a hardware processor communicatively coupled to the memory and configured by the instructions to perform operations comprising:
accessing entity data associated with a first moving entity, the entity data comprising an attribute of the first moving entity with a missing value;
using a machine learning model to determine a predicted value for the attribute based on a set of non-missing values for a set of other attributes of at least one of the first moving entity or a second moving entity related to the first moving entity, the using of the machine learning model to determine the predicted value for the attribute comprising determining an expected distribution of values that are considered within a predicted range for the missing value; and
providing the predicted value for the attribute.

2. The system of claim 1, wherein the using of the machine learning model to determine the predicted value for the attribute based on the set of non-missing values for the set of other attributes of the first moving entity comprises:
using the machine learning model to generate output data based on input data that comprises the set of non-missing values.

3. The system of claim 2, wherein the output data comprises one or more relevant values of one or more other attributes that lead the machine learning model to determine the predicted value.

4. The system of claim 1, wherein the machine learning model is trained on one or more values of one or more other attributes reported by the first moving entity having the missing value.

5. The system of claim 1, wherein the machine learning model comprises a Bayesian Network, and wherein an individual node of the Bayesian Network comprises an independent generalized linear model (GLM).

6. The system of claim 1, wherein the machine learning model comprises a non-linear model.

7. The system of claim 1, wherein the machine learning model comprises a neural network.

8. The system of claim 1, wherein at least one attribute of the set of other attributes is reported by the first moving entity.

9. The system of claim 1, wherein the attribute comprises one of a location, a speed, a heading, a type, and an ownership of the first moving entity.

10. The system of claim 1, wherein the first moving entity comprises one of a ship, an aircraft, or an automotive vehicle.

11. The system of claim 1, wherein the first moving entity comprises a mobile device.

12. A machine-storage medium comprising instructions that, when executed by a hardware processor of a device, cause the device to perform operations comprising:
accessing entity data associated with a first moving entity, the entity data comprising an attribute of the first moving entity with a missing value;
using a machine learning model to determine a predicted value for the attribute based on a set of non-missing values for a set of other attributes of at least one of the first moving entity or a second moving entity related to the first moving entity, the using of the machine learning model to determine the predicted value for the attribute comprising determining an expected distribution of values that are considered within a predicted range for the missing value; and
providing the predicted value for the attribute.

13. The machine-storage medium of claim 12, wherein the using of the machine learning model to determine the predicted value for the attribute based on the set of non-missing values for the set of other attributes of the first moving entity comprises:
using the machine learning model to generate output data based on input data that comprises the set of non-missing values.

14. The machine-storage medium of claim 13, wherein the output data comprises one or more relevant values of one or more other attributes that lead the machine learning model to determine the predicted value.

15. The machine-storage medium of claim 12, wherein the machine learning model comprises a Bayesian Network, and wherein an individual node of the Bayesian Network comprises an independent generalized linear model (GLM).

16. The machine-storage medium of claim 12, wherein the machine learning model comprises a non-linear model.

17. The machine-storage medium of claim 12, wherein the machine learning model comprises a neural network.

18. A method comprising:
accessing, by one or more hardware processors, entity data associated with a first moving entity, the entity data comprising an attribute of the first moving entity with a missing value;
using, by the one or more hardware processors, a machine learning model to determine a predicted value for the attribute based on a set of non-missing values for a set of other attributes of at least one of the first moving entity or a second moving entity related to the first moving entity, the using of the machine learning model to determine the predicted value for the attribute comprising determining an expected distribution of values that are considered within a predicted range for the missing value; and
providing, by the one or more hardware processors, the predicted value for the attribute.

19. The method of claim 18, wherein the using of the machine learning model to determine the predicted value for the attribute based on the set of non-missing values for the set of other attributes of the first moving entity comprises:
using the machine learning model to generate output data based on input data that comprises the set of non-missing values.

20. The method of claim 19, wherein the output data comprises one or more relevant values of one or more other attributes that lead the machine learning model to determine the predicted value.
